(19) United States
(12) Patent Application Publication
(10) Pub. No.: US 2025/0381628 A1
(43) Pub. Date: Dec. 18, 2025

(54) ROBOT WELDING SEQUENCES WITH HUMAN OPERATIONS

(71) Applicant: ILLINOIS TOOL WORKS INC., Glenview, IL (US)

(72) Inventor: Stephen Paul Ivkovich, Petoskey, MI (US)

(21) Appl. No.: 19/229,348

(22) Filed: Jun. 5, 2025

Related U.S. Application Data
(60) Provisional application No. 63/660,616, filed on Jun. 17, 2024.

(51) Int. Cl. B23K 31/02; B23K 37/02

(52) U.S. Cl. CPC B23K 31/02; B23K 37/0252; B23K 37/0258

(57) ABSTRACT

In some examples, a robotic welding system comprises a robot configured pause execution of a robot welding sequence while a human operator performs some human operation related to the robot welding sequence. In some examples, the robot instructions that instruct the robot to pause may be generated dynamically, such as during execution of the robot welding sequence. In some examples, the robot instructions that instruct the robot to pause may be generated at the same time as the rest of the robot instructions of the robot welding sequence. The ability of a robotic welding system to anticipate and/or accommodate human participation and/or human operations during a robot welding sequence opens numerous possibilities for increased human/robot collaboration

### CROSS REFERENCE TO RELATED APPLICATIONS

This application claims priority to, and the benefit of, U.S. Provisional Application No. 63/660,616, filed Jun. 17, 2025, entitled “ROBOT WELDING SEQUENCES WITH HUMAN OPERATIONS,” the entire contents of which are hereby incorporated by reference.

### TECHNICAL FIELD

The present disclosure generally relates to robot welding sequences, and, more particularly, to robot welding sequences with human operations.

### BACKGROUND

Robots are sometimes used to perform welding operations. Robots may be efficient and/or effective at repeatedly performing the same welding-type operation over and over with no boredom, loss of interest, lack of attention, and/or need for bathroom/coffee/lunch breaks. With the ongoing shortage of qualified welding operators, robots may be used more and more to help perform welding operations.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to robot welding sequences with human operations, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example manual (e.g., human operated) welding-type system, in accordance with aspects of this disclosure.

FIG. 2 shows example operator instructions that might be provided to a human operator of the manual welding system of FIG. 1, before or during performance of one or more welding-type operations of a part assembly process, in accordance with aspects of this disclosure.

FIG. 3a shows an example robotic welding system, in accordance with aspects of this disclosure.

FIG. 3b is a block diagram showing additional components and/or interconnections of the robotic welding system of FIG. 3a, in accordance with aspects of this disclosure.

FIG. 4 shows example operator instruction data that might be used to generate robot instructions via the robot instruction generation process of FIG. 5, in accordance with aspects of this disclosure.

FIG. 5 is a flow diagram illustrating an example robot instruction generation process of the robotic welding system of FIGS. 3a-3b, in accordance with aspects of this disclosure.

FIG. 6 is a flow diagram illustrating an example robot instruction execution process of the robotic welding system of FIGS. 3a-3b, in accordance with aspects of this disclosure.

FIGS. 7a-7c show examples of how a robot might operate, and/or operator instructions that might be output, during the robot instruction execution process of FIG. 6, in accordance with aspects of this disclosure.

The figures are not necessarily to scale. Where appropriate, the same or similar reference numerals are used in the figures to refer to similar or identical elements.

### DETAILED DESCRIPTION

Some examples of the present disclosure relate to robot welding sequences with interleaved human operations. More particularly, the disclosure contemplates robot welding sequences that instruct a robot to pause execution of a robot welding sequence while a human operator performs some human operation related to the robot welding sequence. In some examples, the robot instructions that instruct the robot to pause may be generated dynamically, during execution of the robot welding sequence. In some examples, the robot instructions that instruct the robot to pause may be generated at the same time as the rest of the robot instructions of the robot welding sequence. The ability of a robotic welding system to anticipate and/or accommodate human participation and/or human operations during a robot welding sequence opens numerous possibilities for increased human/robot collaboration.

Some examples of the present disclosure relate to a welding system, comprising: a robot comprising a robotic manipulator; a welding-type tool coupled to the robotic manipulator; memory circuitry storing a plurality of machine readable robot instructions relating to performance of a plurality of welding-type operations; and processing circuitry configured to: identify one or more machine readable robot instructions, from the plurality of machine readable robot instructions, that are associated with a particular welding-type operation of the plurality of welding-type operations, determine, based on the one or more machine readable robot instructions, whether the particular welding-type operation is to be performed by the robot or performed by a human operator, in response to determining the particular welding-type operation is to be performed by the human operator, determine when or whether the human operator has completed performance of the particular welding-type operation, and in response to determining the human operator has completed performance of the particular welding-type operation, identify one or more subsequent machine readable robot instructions, of the plurality of machine readable robot instructions, that are associated with a subsequent welding-type operation of the plurality of welding-type operations, the subsequent welding-type operation to be performed directly subsequent to the particular welding-type operation.

In some examples, the processing circuitry is configured to determine when or whether the human operator completed performance of the welding-type operation based on one or more signals received from: a user interface (UI), welding-type equipment, or a sensor. In some examples, the sensor comprises a robot sensor configured to detect when the welding-type tool is attached to or detached from the robotic manipulator, an operator sensor configured to track a position or orientation of the human operator, or an environment sensor configured to monitor an environmental condition of a surrounding environment. In some examples, the processing circuitry is further configured to move the robotic manipulator or the welding-type tool to a remote position away from the particular welding-type operation in response to determining the particular welding-type operation is to be performed by the human operator.

In some examples, the processing circuitry is further configured to: in response to determining the particular welding-type operation is to be performed by the human operator, output, via a user interface, one or more human perceptible instructions relating to performance of the welding-type operation by the human operator. In some examples, the processing circuitry is further configured to: in response to determining the particular welding-type operation is to be performed by the human operator, and a threshold time passing without being able to determine that the human operator has completed performance of the particular welding-type operation: identify the one or more subsequent machine readable robot instructions that are associated with the subsequent welding-type operation, and reschedule the particular welding-type operation to be performed after the subsequent welding-type operation. In some examples, The the processing circuitry is further configured to: determine, based on the one or more subsequent machine readable robot instructions, whether the subsequent welding-type operation is to be performed by the robot or performed by the human operator, in response to determining the subsequent welding-type operation is to be performed by the robot, move the robotic manipulator in a subsequent robot movement pattern defined by the one or more subsequent machine readable robot instructions, and command a piece of welding-type equipment connected to the welding-type tool to output welding-type power, welding wire, or shielding gas to the welding-type tool during movement of the robotic manipulator in the subsequent robot movement pattern.

Some examples of the present disclosure relate to a welding system, comprising: a robot comprising a robotic manipulator; a welding-type tool coupled to the robotic manipulator; a user interface; memory circuitry storing a plurality of robot instructions relating to performance of a plurality of welding-type operations, the plurality of robot instructions comprising first machine readable robot instructions relating to performance of the plurality of welding-type operations; and processing circuitry configured to: in response determining that a human operator will perform one or more human performed welding-type operations of the plurality of welding-type operations, modify, or replace, one or more old robot instructions of the plurality of robot instructions with one or more new robot instructions, the one or more old robot instructions and the one or more new robot instructions relating to the one or more human performed welding-type operations, the one or more new robot instructions comprising second machine readable robot instructions indicating that the human operator will perform the one or more human performed welding-type operations, or instructing the robot to skip performance of the one or more human performed welding-type operations, and control the robot to perform the plurality of welding-type operations according to the plurality of robot instructions.

In some examples, the processing circuitry is configured to determine that the human operator will perform the one or more human performed welding-type operations in response to receiving one or more inputs, via the user interface, indicating that a human operator will perform the one or more human performed welding-type operations. In some examples, the processing circuitry is configured to output, via the user interface, a recommendation that the human operator perform the one or more human performed welding-type operations in response to determining that sensor data captured by a sensor indicates that a situation exists that the human operator is better equipped to deal with than the robot. In some examples, the processing circuitry is configured to determine that the human operator will perform the one or more human performed welding-type operations in response to determining that sensor data captured by a sensor indicates that a situation exists that the human operator is better equipped to deal with than the robot.

In some examples, the situation comprises an issue with: a closeness or contact between two workpieces to be operated upon during the one or more human performed welding-type operations, a number of repeated overlapping passes required during the one or more human performed welding-type operations, an orientation of a joint between the two workpieces to be operated upon during the one or more human performed welding-type operations, or a position of a workpiece to be operated upon during the one or more human performed welding-type operations. In some examples, the one or more new robot instructions specify how or where to position the robot during the human performed welding-type operation, or specify that the robot should delay continuing with performance of the plurality of welding-type operations until a particular condition is met. In some examples, the one or more new robot instructions include a reference to, or a copy of, operator instruction data representative of one or more human perceptible operator instructions relating to human performance of the one or more human performed welding-type operations.

Some examples of the present disclosure relate to a welding system, comprising: a robot comprising a robotic manipulator; a welding-type tool coupled to the robotic manipulator; a user interface; memory circuitry storing: operator instruction data representative of human perceptible instructions for human performance of a plurality of welding-type operations of a part assembly process, and human-robot operation data that indicates which one or more human performed welding-type operations, of the plurality of welding-type operations, should be performed by a human operator, and which one or more robot performed welding-type operations, of the plurality of welding-type operations, should be performed by the robot; and processing circuitry configured to: generate machine readable robot instructions based on the operator instruction data and the human-robot operation data, the machine readable robot instructions specifying how or when the robot should perform the one or more robot performed welding-type operations.

In some examples, the machine readable robot instructions further specify that the robot should not to perform the one or more human performed welding-type operations. In some examples, the machine readable robot instructions further specify how or where to position the robot during the one or more human performed welding-type operations. In some examples, the machine readable robot instructions further specify that the robot should delay continuing with performance of the one or more robot performance welding-type operations until a particular condition is met.

In some examples, the machine readable robot instructions include a reference to, or a copy of, operator instruction data representative of one or more human perceptible operator instructions relating to human performance of the one or more human performed welding-type operations. In some examples, the user interface is configured to receive one or more inputs comprising the human-robot operation data, or the processing circuitry is further configured to generate the human-robot operation data based on an analysis of the operator instruction data.

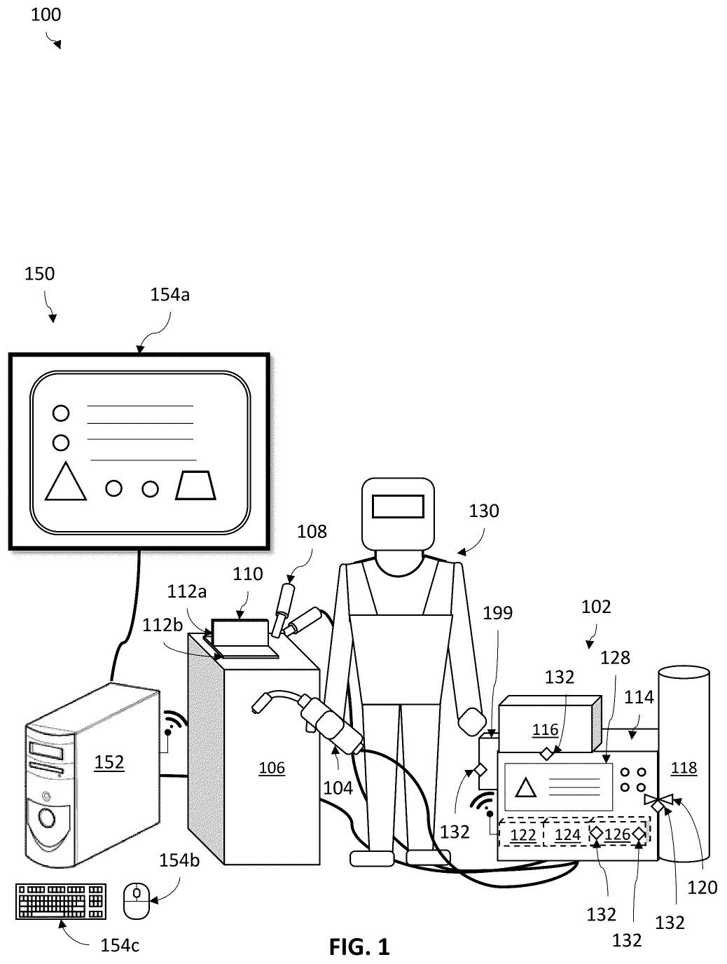

FIG. 1 shows an example of a manual (e.g., human operated) welding-type system 100. As shown, the manual welding-type system 100 includes welding-type equipment 102, a welding-type tool 104, and a computing system 150. The welding-type equipment 102 is shown as connected to (and/or in electrical communication with) a welding bench 106 via a clamp 108 and clamp cable. The welding bench 106 is shown supporting a simple example of a part 110 that is comprised of two workpieces 112. The welding-type equipment 102 is further shown as connected to (and/or in electrical communication with) the welding-type tool 104 via a tool cable.

While depicted in FIG. 1 as a manual (and/or hand-held) welding torch or gun configured for gas metal arc welding (GMAW), in some examples, the welding-type tool 104 may instead be a different welding-type tool 104. For example, the welding-type tool 104 may be an electrode holder (i.e., stinger) configured for shielded metal arc welding (SMAW), a torch and/or filler rod configured for gas tungsten arc welding (GTAW), a welding gun configured for flux-cored arc welding (FCAW), and/or a plasma cutter. In the example of FIG. 1, a holster 199 for the welding-type tool 104 is shown connected to the welding-type equipment 102.

In some examples, the welding-type equipment 102 is configured to provide welding-type power and/or consumables to the welding-type tool 104. In some examples, the welding-type tool 104 may transmit one or more signals to the welding-type equipment 102 (and/or other components of the weld tracking system 100) when activated, so that the welding-type equipment 102 knows to provide welding-type power and/or consumables to the welding-type tool 104.

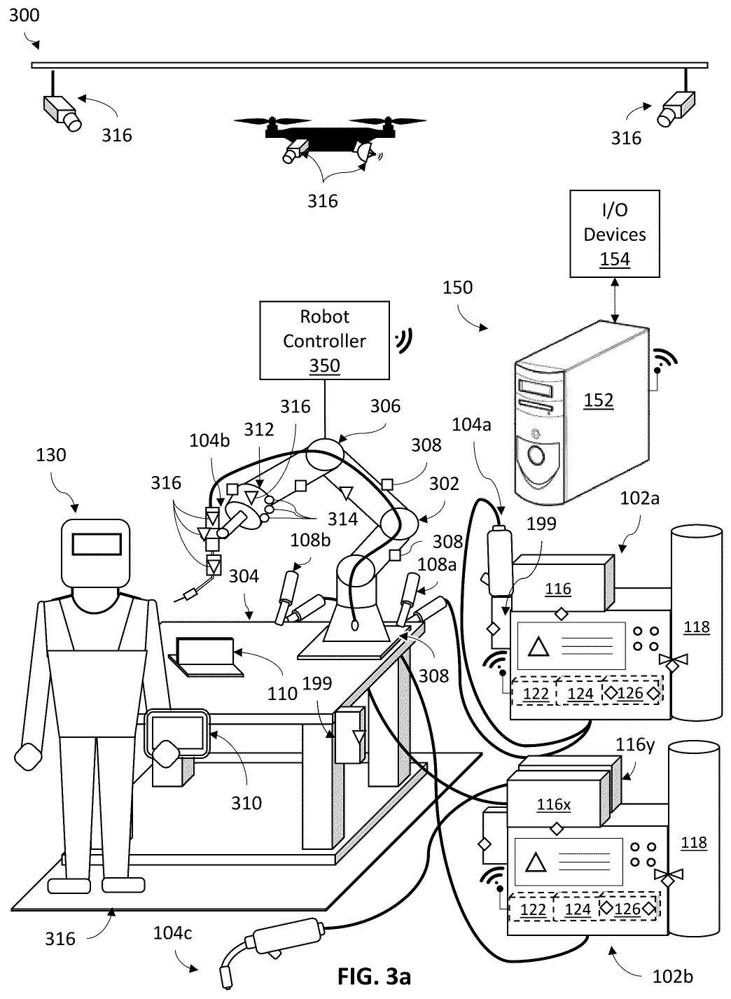

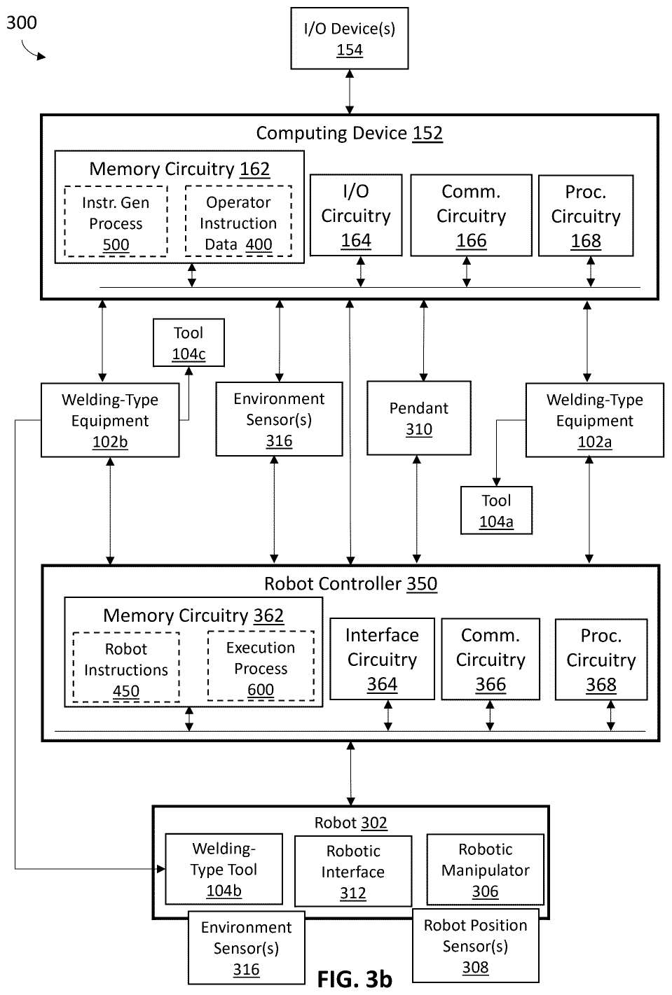

In the example of FIG. 1, the welding-type equipment 102 comprises a welding-type power supply 114, wire feeder 116, and gas supply 118. Though only one wire feeder 116 is shown in the example of FIG. 1, in some examples, the welding-type equipment 102 may be comprised of several wire feeders 116 (see, e.g., FIG. 3a). In some examples, the wire feeder(s) 116 may be configured to feed (e.g., electrode) wire to the welding-type tool 104 (e.g., via one or more motorized rollers).

As shown, the welding-type equipment 102 includes a gas supply 118. In some examples, the gas supply 118 may be configured to supply shielding gas to the welding-type tool 104 through the welding-type power supply 114. As shown, the welding-type power supply 114 includes one or more gas valves 120 that may control a flow rate of the gas through the welding-type power supply 114 and/or to the welding-type tool 104.

In the example of FIG. 1, the power supply 114 includes power communication circuitry 122, power control circuitry 124, and power conversion circuitry 126 interconnected with one another. In some examples, the power control circuitry 124 may include processing circuitry and/or memory circuitry. In some examples, the power conversion circuitry 126 may be configured to receive input power (e.g., from a generator, a battery, mains power, etc.) and convert the input power to welding-type output power, such as might be suitable for use by the welding-type tool 104 for welding-type operations.

In some examples, the power conversion circuitry 126 may include circuit elements (e.g., transformers, rectifiers, capacitors, inductors, diodes, transistors, switches, and so forth) capable of converting the input power to output power. In some examples, the power conversion circuitry 126 may also include one or more controllable circuit elements (e.g., switches, relays, transistors, etc.) configured to change states (e.g., fire, turn on/off, close/open, etc.) based on one or more control signals. In some examples, the state(s) of the controllable circuit elements may impact the operation of the power conversion circuitry 126, and/or impact characteristics (e.g., current/voltage magnitude, frequency, waveform, etc.) of the output power provided by the power conversion circuitry 126.

In some examples, the power control circuitry 124 may be configured to control operation of the power communication circuitry 122, power conversion circuitry 126, wire feeder 116, gas supply 118, and/or gas valve(s) 120 (e.g. via one or more control signals). For example, the power control circuitry 124 may control the power conversion circuitry 126 via one or more control signals delivered to the controllable circuit elements of the power conversion circuitry 126. In some examples, the power control circuitry 124 may control the power communication circuitry 122, power conversion circuitry 126, wire feeder 116, and/or gas supply 118 based on one or more equipment parameters and/or welding parameters (e.g., input via an operator interface 128 and/or received from a robot 302).

In the example of FIG. 1, the operator interface 128 comprises one or more display screens, touch screens, knobs, buttons, levers, switches, joysticks, foot pedals microphones, vibration sensors, speakers, lights, gesture recognition cameras, and/or other mechanisms through which a human operator 130 may provide input to, and/or receive output from, the welding-type equipment 102. For example, an operator 130 may use the operator interface 128 to input one or more welding and/or equipment parameters (e.g., target voltage/current, target wire feed speed, wire/filler type, wire/filler diameter, gas type, target gas flow rate, welding-type process, material type of workpiece 112, etc.). As another example, the operator 130 may use the operator interface 128 to view and/or otherwise understand the existing equipment parameters of the welding-type equipment 102.

While shown as part of the power supply 114 in FIG. 1, in some examples, the operator interface 128, valve(s) 120, power control circuitry 124, and/or power communication circuitry 122 (and/or some other control/communication circuitry) may be part of the wire feeder 116. In some examples, the power communication circuitry 122 may be configured to facilitate communication with the welding-type tool 104. In some examples, the power communication circuitry 122 may be configured to facilitate communication with a computing system 150 and/or one or more other external systems (e.g., a robot 302).

In the example of FIG. 1, the welding-type equipment 102 also includes equipment sensors 132. As shown, the equipment sensors 132 are connected to, and/or positioned proximate, the power control circuitry 124, power conversion circuitry 126, wire feeder 116, gas valve 120, and holster 199. In some examples, the equipment sensors 132 may comprise one or more wire feed speed sensors (e.g., tachometers) that detect a wire feed speed of the wire feeder 116. In some examples, the equipment sensors 132 may comprise one or more gas flow rate sensors that detect a gas flow rate of shielding gas flowing from the gas supply 118, through the gas valve 120, and/or to the welding-type tool 104. In some examples, the equipment sensors 132 may comprise one or more proximity and/or presence sensors that detect when a welding-type tool 104 is positioned and/or held in the holster 199.

In some examples, the equipment sensor(s) 132 may comprise one or more current sensors that detect an electrical current (and/or output) of the power conversion circuitry 126 and/or welding-type power supply 114. For example, the current sensor(s) may detect a magnitude, phase, frequency, and/or polarity of electrical current sent by the welding-type power supply 114 (e.g., via the power conversion circuitry 126) to and/or through the welding-type tool 104 and/or clamp 108 (e.g., via the tool cable and/or clamp cable).

In some examples, the equipment sensor(s) 132 may comprise one or more voltage sensors that detect a voltage drop across the outputs (e.g., tool cable and clamp cable) of the power conversion circuitry 126 and/or welding-type power supply 114. As the outputs of the welding-type power supply 114 are electrically connected on one end to the welding-type tool 104 (e.g., via the tool cable) and at the other end to the welding bench 106 and/or part 110 (e.g., via the clamp cable), in some examples, the voltage sensor(s) detects the voltage difference between the welding-type tool 104 and the part 110 (or welding bench 106). While shown as part of the welding-type power supply 114 in the example of FIG. 1, in some examples, some of the equipment sensor(s) 132 may be part of the tool cable, the clamp cable, the clamp 108, and/or the welding-type tool 104.

In the example of FIG. 1, the manual welding-type system 100 further includes a computing system 150. As shown, the computing system 150 includes a computing device 152 and several computing input/output devices (I/O) devices 154. While shown as a desktop computer in the example of FIG. 1, in some examples, the computing device 152 may instead be some other appropriate computational apparatus, such as, for example, a laptop computer, a tablet computer, a smart phone, and/or a web server. Though shown as being physically connected to the welding-type equipment 102 via a computer cable, in some examples, the computing device 152 may instead be in wireless communication with the welding-type equipment 102 (and/or other devices). In some examples, the computing system 150 may be implemented via the welding-type equipment 102.

In the example of FIG. 1, the I/O devices 154 of the computing system 150 include input devices (e.g., a keyboard and mouse) as well as output devices (e.g., a display screen and speakers). In some examples, the input devices may include, for example, one or more keyboards, mice, touch screens, remote controls, and/or other suitable input devices. In some examples, the output devices may include, for example, one or more display screens, speakers, and/or other suitable output devices.

In some examples, the computing I/O devices 154 may include one or more (e.g., CD, DVD) drives, (e.g., USB) ports, and/or other devices through which the computing system 150 may interface with local storage devices. In some examples, the computing I/O devices 154 are electrically connected and/or in electrical communication with the computing device 152.

In the example of FIG. 1, a display screen computing I/O device 154a is shown proximate the human operator 130. In some examples, the computing system 150 may display instructions for the human operator 130 via the display screen computing I/O device 154a to guide the human operator 130 in the performance of one or more welding-type operations on one or more workpieces 112 supported on the welding bench 106. In some examples, other computing I/O devices 154 of the computing system 150 may likewise output instructions for the human operator 130 to guide the human operator 130 in the performance of the one or more welding-type operations.

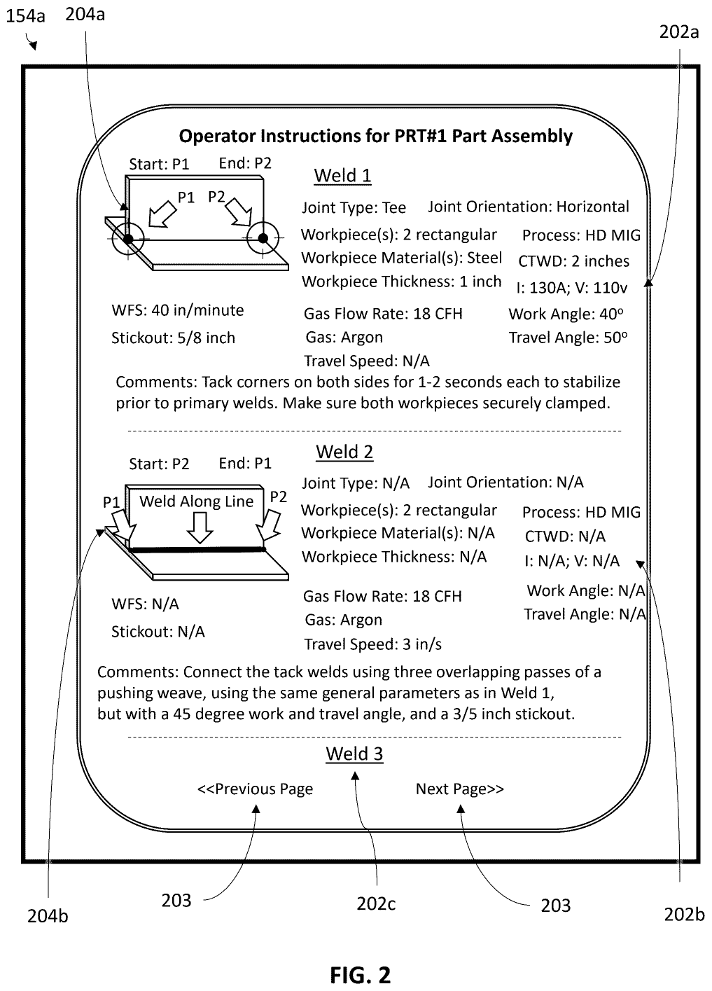

FIG. 2 shows a simple example of operator instructions 202 that might be shown to the human operator 130 via the display screen computing I/O device 154a. The operator instructions 202 are shown as being presented in an ordered sequence, such that the human operator 130 will know to perform a first set of welding-type operations according to a first set of operator instructions 202a, then perform the next (e.g., second) set of welding-type operations according to the next (e.g., second) set of operator instructions 202b, and so on and so forth. While only two complete sets of operator instructions 202 are shown in the example of FIG. 2, the bottom of the display screen computing I/O device 154a also shows selectable buttons/links 203 that may be selected (e.g., via manipulation of a mouse computing I/O device 154b) to view previous and/or subsequent operator instructions 202.

In the example of FIG. 2, all of the set of operator instructions 202 relate to assembly of a particular part, identified as PRT #1. As shown, each set of operator instructions 202 includes various welding parameter fields, equipment parameter fields, and/or technique parameter fields. Each parameter field is shown accompanied by a parameter identifier and/or parameter value. For example, the first set of operator instructions 202a (i.e., Weld 1) is shown as including welding parameter fields, identifiers, and/or values for joint type, joint orientation, workpiece shape/type, workpiece material, workpiece thickness, gas type, and start/end positions. In some examples, alternative and/or additional welding parameters may also be included, such as, for example, wire diameter, weld/operation length, type of welding-type operation, type/identifier of welding-type tool 104, and/or type/identifier of part 110 being assembled.

The first set of operator instructions 202 (i.e., Weld 1) is further shown as including equipment parameter fields and/or values for welding-type process, target current (I), target voltage (V), wire feed speed (WFS), and gas flow rate. In some examples, alternative and/or additional equipment parameters may also be included, such as, for example, target current/voltage range.

The first set of operator instructions 202 (i.e., Weld 1) is further shown as including technique parameter fields and/or values for work angle, travel angle, travel speed, stickout, and contact tip to work distance (CTWD). In some examples, alternative and/or additional technique parameters may be included, such as, for example, travel direction, push/pull, one of more multi-pass characteristics (e.g., root pass characteristics, cover pass characteristics, etc.), and/or one or more weave characteristics (e.g., frequency, weave width, dwell time, etc.). In some examples, travel direction may be additionally, or alternatively, determined based on start/end positions. While these welding, equipment, and/or technique parameter fields and/or values are shown in the example of FIG. 1, in some examples additional, or alternative, welding parameter, equipment parameter, and/or technique parameter fields and/or values may be used in the operator instructions.

In the example of FIG. 2, the first and second sets of operator instructions 202 also include a visual depiction 204 of the workpieces 112 and/or the position(s) where the welding-type operation(s) should occur. While only one visual depiction 204 is shown for each of the first and second set of operator instructions 202, in some examples a set of operator instructions 202 may include several visual depictions 204. In some examples, one or more of the visual depictions 204 may be photographic images, videos, 3D model views, schematics, drawings, mockups, and/or other visual representations of the workpiece(s) 112 and/or the position(s) where the welding-type operation(s) should occur. As shown, the visual depictions 204 are also annotated with arrows and reticles to further indicate, highlight, and/or emphasize important parts of the visual depiction 204 (e.g., relating to the position(s) where the welding-type operation(s) should occur).

In the example of FIG. 2, each set of operator instructions 202 further includes a comment section where additional information may be set forth. In some examples, the comments may help to draw attention to certain aspects of the welding-type operation, underscore certain steps, warn against common errors, and/or otherwise include additional information to guide the human operator 130 in the performance of the welding-type operation. For example, the comments in the first set of operator instructions 202 (i.e., Weld 1) indicate that the human operator 130 should actually perform two short “tack” welds at each of the start and end positions. The comments in the second set of operator instructions 202 (i.e., Weld 2) indicate that the human operator 130 should perform a weld between the start and end positions by “pushing” and “weaving” the welding-type tool 104 over the course of several overlapping passes.

In some examples, the computing system 150 may “translate” and/or “convert” operator instructions 202 (e.g., such as shown in FIG. 2) to machine readable robot instructions that can be read and/or executed by a robot 302 and/or robot controller 350 (see, e.g., FIG. 3a). In some examples, this translation and/or conversion may involve an analysis of the operator instructions 202 to identify the welding, equipment, and/or technique parameter values specified in the operator instructions 202.

A parameter analysis of the operator instructions 202 may be relatively simple where most of the parameter values are associated with parameter fields (and/or field identifiers). For instance, the first set of operator instructions 202a in FIG. 2 are shown with most of the parameter fields being associated with corresponding parameter values (e.g., the “Joint Type” parameter field is associated with the “Tee” parameter value). However, the second set of operator instructions 202b in FIG. 2 has null values associated with many of the parameter fields, reflecting the possibility that some operator instructions 202 may be less conducive to simple parsing of parameter fields. In examples, where most of the parameter values are not associated with parameter fields (and/or field identifiers), a more in depth analysis may be warranted.

In some examples, the translation/conversion of the operator instructions 202 may use one or more large language models, neural networks, natural language processing techniques, and/or machine learning techniques to analyze the operator instructions 202 and/or identify parameter values. Such techniques may be helpful, for example, in parsing sentences and/or paragraphs of instructions to find parameter values (e.g., in the comments). In some examples, computer vision techniques, and/or other image analysis techniques, may also be used to analyze the visual depiction(s) 204 and/or identify parameter values (e.g., start and/or end positions). Once the parameter values are identified, the computing system 150 may generate machine readable robot instructions for a robot 302 based on the parameter values.

FIG. 3a shows an example of a robotic welding-type system 300. In the example of FIG. 3a, the robotic welding-type system 300 includes some of the same components as the manual welding-type system 100 of FIG. 1. For example, the robotic welding-type system 300 includes a computing system 150, welding-type equipment 102, and a welding-type tool 104. However, whereas the manual welding-type system 100 of FIG. 1 only included one piece of welding-type equipment 102 and one welding-type tool 104, the robotic welding-type system 300 is shown as including two pieces of welding-type equipment 102, and three welding-type tools 104.

In the example of FIG. 3a, the first piece of welding-type equipment 102a is the same as the welding-type equipment 102 shown in FIG. 1. As shown, the welding-type equipment 102a is connected to a clamp 108a and a (e.g., manual and/or hand-held) first welding-type tool 104a, which is secured in the holster 199 of the welding-type equipment 102a. In some examples, the welding-type equipment 102a might be used by the human operator 130 at times when a human operator 130 may be better suited than a robot 302 to perform a welding-type operation.

The second piece of welding-type equipment 102b is shown as being similar to the first piece of welding-type equipment 102a. For instance, in the example of FIG. 3a, the welding-type equipment 102b is shown connected to a clamp 108b, similar to the welding-type equipment 102a. However, unlike the first piece of welding-type equipment 102a, the second piece of welding-type equipment 102b has two wire feeders 116x and 116y instead of one wire feeder 116.

One of the wire feeders 116x is shown as being connected to (and/or in electrical communication with) a second welding-type tool 104b that is held by a robot 302 of the robotic welding-type system 300. The other wire feeder 116y is shown as being connected to (and/or in electrical communication with) a (e.g., manual and/or hand-held) third welding-type tool 104c. In some examples, the welding-type equipment 102b (and/or the welding-type tool 104b) might be used by both the human operator 130 and the robot 302.

In the example of FIG. 3a, the robot 302 is attached to a work table 304, along with the clamps 108 and a holster 199. As shown, the work table 304 supports the part 110 and the robot 302. In some examples, the work table 304 may be electrically conductive, so as to conduct welding-type power from the welding-type equipment 102 and/or welding-type tool 104 (held by the robot 302) to the part 110.

In the example of FIG. 3a, the robot 302 comprises a robotic manipulator 306 with several segments interconnected by joints that allow the robotic manipulator 306 to move in several degrees of freedom. For example, each joint may have one or more degrees of freedom, to allow the robotic manipulator 306 to achieve multiple orientations for accessing one or more weld joints on a part 110. In some examples, the robotic manipulator 306 may instead be different, and/or the robot 302 may include an additional robotic manipulator. As shown, the robotic manipulator 306 is secured to the work table 304 via a base 308.

In some examples, the robot 302 may be configured as a collaborative robot, or cobot. Whereas conventional welding robots may be confined within a cage or otherwise contained within a weld cell that is protected against intrusion during robot operations, cobots may instead be configured to operate in a manner such that humans do not necessarily need to be excluded from the area in which the robot 302 is operating. For example, the robot 302 may rapidly detect and/or respond to collisions, may operate with reduced speed and/or joint torque relative to conventional welding robots, and/or implement other features designed to facilitate close collaboration between robot 302 and human operator 130.

In the example of FIG. 3a, the robot further includes (and/or is connected with) a robot controller 350. In some examples, the robot controller 350 may be configured to control robot operations of the robot 302. For example, the robotic manipulator 306 may include (and/or be connected to) several motors and/or actuators configured to move the robotic manipulator 306, and the robot controller 350 may control movement of the robotic manipulator 306 via control of these motors and/or actuators.

In the example of FIG. 3a, the robot 302 further includes several robot position sensors 308. As shown, the robot position sensors 308 are attached to the robotic manipulator 306. While termed robot position sensors 308, in some examples, the robot position sensors 308 may be configured to detect both the position and/or the orientation of one or more of the segments of the robotic manipulator 306. In some examples, the robot position sensors 308 may be configured to detect the position and/or orientation of the welding-type tool 104 attached to the robotic manipulator 306.

In some examples, the robot controller 350 may use data detected by the robot position sensor(s) 308 to track the position and/or orientation of the robot 302 and/or welding-type tool 104b, and/or guide robot operations of the robot 302. In some examples, the robot controller 350 may additionally, or alternatively, track the position and/or orientation of the robot 302 and/or welding-type tool 104b through an understanding of some default and/or initial position and/or orientation of the robot 302, and the impact of one or more particular articulations, manipulations, and/or movements of the robot 302 and/or robotic manipulator 306 (e.g., made since the robot 302 and/or robotic manipulator 306 was in the default and/or initial position and/or orientation).

In some examples, the robot 302 (and/or robot controller 350) may be in communication with the welding-type equipment 102b (e.g., via the power communication circuitry 122). In some examples, the communication may be wireless and/or wired. In some examples, electrical leads connected to the robot 302 and/or robot controller 350 may be spliced into the welding cable coupling the welding-type tool 104 to the welding-type equipment 102b, such that wired communication between the robot 302 (and/or robot controller 350) and welding-type equipment 10b2 may occur via the welding cable. In some examples, a separate wired connection may be made between the robot 302 (and/or robot controller 350) and the welding-type equipment 102b.

In some examples, the welding-type equipment 102b and robot 302 may communicate by way of one or more signals. In some examples, the robot 302 (and/or robot controller 350) may transmit and/or receive one or more commands, requests, responses, acknowledgements, data, and/or other messages to/from the welding-type equipment 102b. In some examples, the robot 302 (and/or robot controller 350) may transmit one or more target welding parameters (e.g., target voltage, target current, target wire feed speed, target gas flow rate, target welding-type process, etc.) to the welding-type equipment 102b. In some examples, the welding-type equipment 102b may configure, control, and/or adjust its operation based on and/or according to the welding parameters. In some examples, the welding-type equipment 102b may, in turn, transmit one or more actual/detected welding parameters to the robot 302 (e.g., actual/detected voltage, current, wire feed speed, gas flow rate, welding-type process etc.).

In some examples, the robot 302 (and/or robot controller 350) may transmit a trigger (and/or activation) command to the welding-type equipment 102b. In some examples, the welding-type equipment 102 may output welding-type power, wire (e.g., from the wire feeder 116x), and/or shielding gas in response to the trigger command. In some examples, the welding-type equipment 102b may cease output of welding-type power, wire, and/or shielding gas in the absence of the trigger command, and/or in response to some other command (e.g., deactivate, disable, etc.).

In some examples, the robot controller 350 may send a trigger/activation command to the welding-type equipment 102b when the robotic manipulator 306 has manipulated the welding-type tool 104b into proper position for a welding-type operation, and the timing is right for the welding-type operation. In some examples, the robot 302 may be programmed with the proper positioning and/or timing information, and this may be stored in memory circuitry of the robot controller 350. In this way, the robot controller 350 may control the movement of the robot 302 and the activation/deactivation of the welding-type tool 104b, welding-type equipment 102b, and/or welding-type operations according to prior programming.

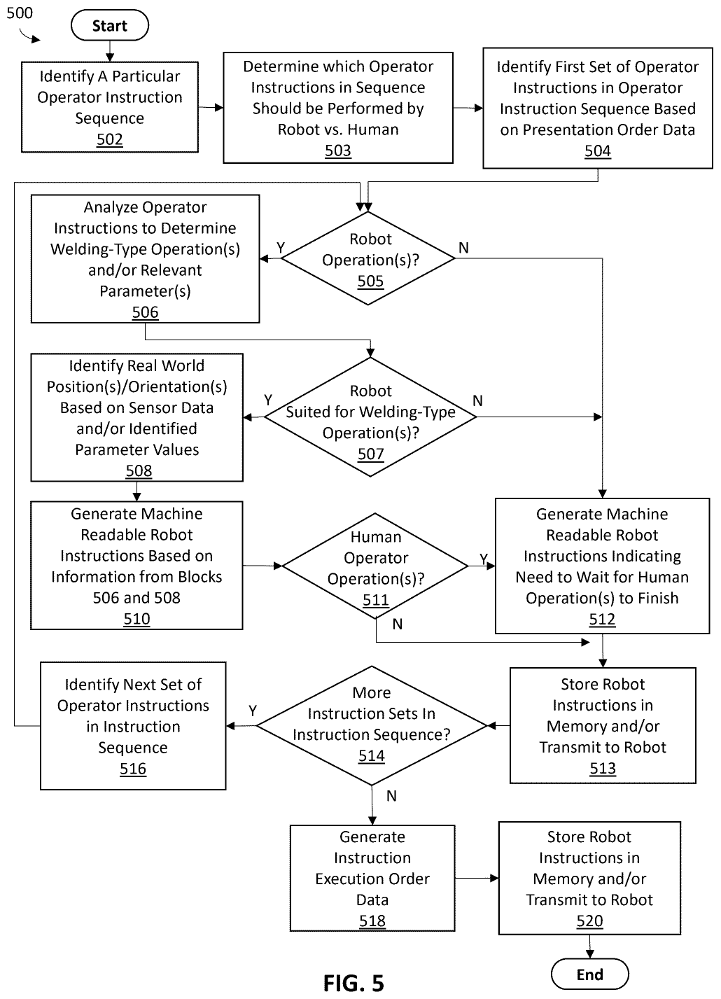

In some examples, the robot 302 may be programmed via a robot instruction generation process 500 of the computing system 150 (see, e.g., FIG. 3b). The robot instruction generation process 500 may analyze existing human operator instructions and generate, based on the human operator instructions, machine instructions that the robot 302 (and/or robot controller 350) can read, understand, and/or execute. The robot instruction generation process 500 is discussed further below (e.g., with respect to FIG. 5).

In some examples, the robot 302 may be programmed (and/or reprogrammed) via a pendant 310. In the example of FIG. 3a, the human operator 130 is shown holding the pendant 310. In some examples, the human operator 130 may use the pendant 310 to view operator instructions 202, and/or to add to and/or change the machine instructions generated by the robot instruction generation process 500. In some examples, the pendant 310 may also be considered part of the robotic welding-type system 300. In some examples, the pendant 310 may serve as a user interface of the computing device 152, robot 302, robot controller 350, and/or the welding-type equipment 102.

In some examples, the pendant 310 may be in (e.g., wired and/or wireless) communication with the robot 302, robot controller 350, and/or computing device 152. Through this communication link, information may be transmitted to the robot 302, robot controller 350, and/or computing device 152 from the pendant 310, and/or received from the robot 302, robot controller 350, and/or computing device 152 at the pendant 310. In some examples, the pendant 310 may include one or more input mechanisms (e.g., knobs, buttons, touch screens, sliders, dials, microphones, keyboards, pointers, joysticks, etc.) and/or output mechanisms (e.g., lights, display screens, speakers, haptic devices, etc.) through which the human operator 130 can provide input to the computing device 152, robot 302, robot controller 350, and/or the welding-type equipment 102 and/or perceive data related to operation of the computing device 152, robot 302, robot controller 350, and/or the welding-type equipment 102.

In some examples, the robot 302 may be programmed (and/or reprogrammed) more directly. For example, the robot 302 may be configured so that the human operator 130 may be able to physically grab and move the robotic manipulator 306 to a particular position and/or orientation. Thereafter, the human operator 130 may provide an input to the robot 302 to “teach” or program the robot 302 to remember that position/orientation as part of an upcoming welding-type operation.

In the example of FIG. 1, the end of the robotic manipulator 306 (opposite the base 308) includes (and/or attaches to) a robotic interface 312. In some examples, the robotic interface 312 may be attached to (and/or extend from) a wrist of the robotic manipulator 306. As shown the robotic interface 312 includes robot input/output (I/O) devices 314 (e.g., knobs, buttons, touch screens, sliders, dials, microphones, keyboards, pointers, joysticks, lights, display screens, speakers, etc.) configured to allow the operator 130 to provide direct input to, and/or receive output from, the robot 302. In some examples, the robot I/O devices 314 may be in electrical communication with the robot controller 350.

In some examples, the operator 130 may use the robot I/O devices 314 to tell the robot controller 350 to put the robot 302 into a movable (e.g., low torque) mode so that the operator can manually (e.g., by hand) move the robotic manipulator 306 around to a desired position. In some examples, the operator 130 may use the robot I/O devices 314 to program (and/or reprogram) the robot 302, such as, for example, providing an input to indicate to the robot controller 350 that the current position/orientation of the robot 302 should be remembered for a future welding-type operation. In some examples, the operator 130 may use the robot I/O devices 314 to manually activate the welding-type tool 104 (e.g., by activating an input that sends an appropriate signal to the welding-type equipment 102).

In the example of FIG. 1, the manual welding-type system 100 also includes several environment sensors 316 configured to detect one or more environmental and/or operational parameters. As shown, the environment sensors 316 are attached to (and/or retained by) the robotic manipulator 306, the robotic interface 312, the welding-type tool 104b, and a bracket connecting the welding-type tool 104 to the robot 302. Other environment sensors 316 are shown unattached to the robot 302 or the welding-type tool 104b, and are instead shown attached to the tool holster 199, a ceiling fixture, a floor mat, and an unmanned aerial vehicle.

In some examples, the environment sensors 316 may detect various environmental information via acoustic, thermal, ultrasonic, infrared, electromagnetic, sonar, and/or other means. In some examples, one or more of the environment sensors 316 may be camera and/or optical sensors configured to capture images that may be analyzed (e.g., using various computer vision techniques) to determine position/orientation information of the robot 302, welding-type tool 104, workpiece(s) 112, joints, welding positions, and/or other various environmental and/or operational information. In some examples, one or more of the environment sensors 316 may use short range communication devices, such as, for example, radio frequency identification (RFID), near field communication (NFC), and/or Bluetooth devices. In some examples, one or more of the environment sensors 316 may comprise range finding sensors, proximity sensors, and/or pressure sensors.

FIG. 3b is a block diagram showing components and/or connections of the robotic welding-type system 300. For example, FIG. 3b shows both the computing device 152 and robot controller 350 communicatively connected to both the welding-type equipment 102a and welding-type equipment 102b. Both the computing device 152 and the robot controller 350 are also shown communicatively connected to at least some environment sensors 316. The robot controller 350 is further shown communicatively connected with the pendant 310 and the robot 302 (and/or the robot positions sensor(s) 308 and/or environment sensor(s) 316 of the robot 302). Finally, the computing device 152 and the robot controller 350 are shown communicatively connected to one another.

FIG. 3b also shows internal components of the computing device 152 and robot controller 350. In the example of FIG. 3b, the robot controller 350 includes robot memory circuitry 362, robot interface circuitry 364, robot communication circuitry 366, and robot processing circuitry 368 interconnected with one another via a common electrical bus. In some examples, the interface circuitry 364 may comprise one or more drivers for the robotic interface 312 and/or pendant 310. In some examples, the interface circuitry 364 may be configured to generate one or more signals representative of input received via the robotic interface 312 (and/or pendant 310), and provide the signal(s) to the bus. In some examples, the interface circuitry 364 may also be configured to control the robotic interface 312 (and/or pendant 310), to generate one or more outputs in response to one or more signals (e.g., received via the bus).

In some examples, the robot communication circuitry 366 may include one or more wireless adapters, wireless cards, cable adapters, wire adapters, dongles, radio frequency (RF) devices, wireless communication devices, Bluetooth devices, IEEE 802.11-compliant devices, WiFi devices, cellular devices, GPS devices, Ethernet ports, network ports, lightning cable ports, and/or cable ports. In some examples, the robot communication circuitry 366 may be configured to facilitate communication via one or more wired mediums (e.g., Ethernet cable(s), universal serial bus cable(s), etc.) and/or protocols and/or wireless mediums and/or protocols (e.g., cellular communication, long term evolution (LTE), NFC, RFID, Message Queuing Telemetry Transport (MQTT), general packet radio service (GPRS), IEEE 802.11, and/or ultra high frequency radio wave (commonly known as Bluetooth) protocols). In some examples, the robot communication circuitry 366 may be coupled to one or more antennas to facilitate wireless communication.

In some examples, the robot communication circuitry 366 may be configured to facilitate communications of the robot controller 350. In some examples, the robot communication circuitry 366 may receive one or more signals (e.g., from the computing device 152, welding-type equipment 102b, etc.) decode the signal(s), and provide the decoded data to the electrical bus. As another example, the robot communication circuitry 366 may receive one or more signals from the electrical bus (e.g., representative of one or more inputs received via the interface circuitry 364 and/or robotic interface 312) encode the signal(s), and transmit the encoded signal(s) to an external device (e.g., computing device 152, welding-type equipment 102, etc.).

In some examples, the robot processing circuitry 368 may comprise one or more processors. In some examples, the robot processing circuitry 368 may comprise one or more drivers for the environment sensors 316 and/or position sensors 308. In some examples, the robot processing circuitry 368 may be configured to execute machine readable instructions stored in the robot memory circuitry 362.

In the example of FIG. 3b, the computing device 152 includes computing memory circuitry 162, computing I/O circuitry 164, computing communication circuitry 166, and computing processing circuitry 168 interconnected with one another via a common electrical bus. In some examples, the computing I/O circuitry 164 may comprise one or more drivers for the computing I/O device(s) 154. In some examples, the computing I/O circuitry 164 may be configured to generate one or more signals representative of input received via input device(s) of the computing I/O device(s) 154, and provide the signal(s) to the bus. In some examples, the computing I/O circuitry 164 may also be configured to control the output device(s) of the computing I/O device(s) 154 to generate one or more outputs in response to one or more signals (e.g., received via the bus).

In some examples, the computing communication circuitry 166 may include one or more wireless adapters, wireless cards, cable adapters, wire adapters, dongles, radio frequency (RF) devices, wireless communication devices, Bluetooth devices, IEEE 802.11-compliant devices, WiFi devices, cellular devices, GPS devices, Ethernet ports, network ports, lightning cable ports, and/or cable ports. In some examples, the computing communication circuitry 166 may be configured to facilitate communication via one or more wired mediums (e.g., Ethernet cable(s), universal serial bus cable(s), etc.) and/or protocols and/or wireless mediums and/or protocols (e.g., cellular communication, long term evolution (LTE), NFC, RFID, MQTT, general packet radio service (GPRS), IEEE 802.11, and/or ultra high frequency radio wave (commonly known as Bluetooth) protocols). In some examples, the computing communication circuitry 166 may be coupled to one or more antennas to facilitate wireless communication.

In some examples, the computing communication circuitry 166 may be configured to facilitate communications of the computing device 152. In some examples, the computing communication circuitry 166 may receive one or more signals (e.g., from the robot controller 350, welding-type equipment 102, etc.) decode the signal(s), and provide the decoded data to the electrical bus. As another example, the computing communication circuitry 166 may receive one or more signals from the electrical bus (e.g., representative of one or more inputs received via the computing I/O circuitry 164 and/or computing I/O device(s) 154) encode the signal(s), and transmit the encoded signal(s) to an external device (e.g., the robot controller 350, welding-type equipment 102, etc.).

In some examples, the computing processing circuitry 168 may comprise one or more processors, controllers, and/or graphical processing units (GPUs). In some examples, the computing processing circuitry 168 may comprise one or more drivers for the environment sensors 316, position sensors 308, and/or equipment sensors 132. In some examples, the computing processing circuitry 168 may be configured to execute machine readable instructions stored in the computing memory circuitry 162.

In the example of FIG. 3b, the computing memory circuitry 162 includes (and/or stores) operator instruction data 400 and a robot instruction generation process 500. As shown, the robotic memory circuitry includes (and/or stores) robot instructions 450 and a robot instruction execution process 600.

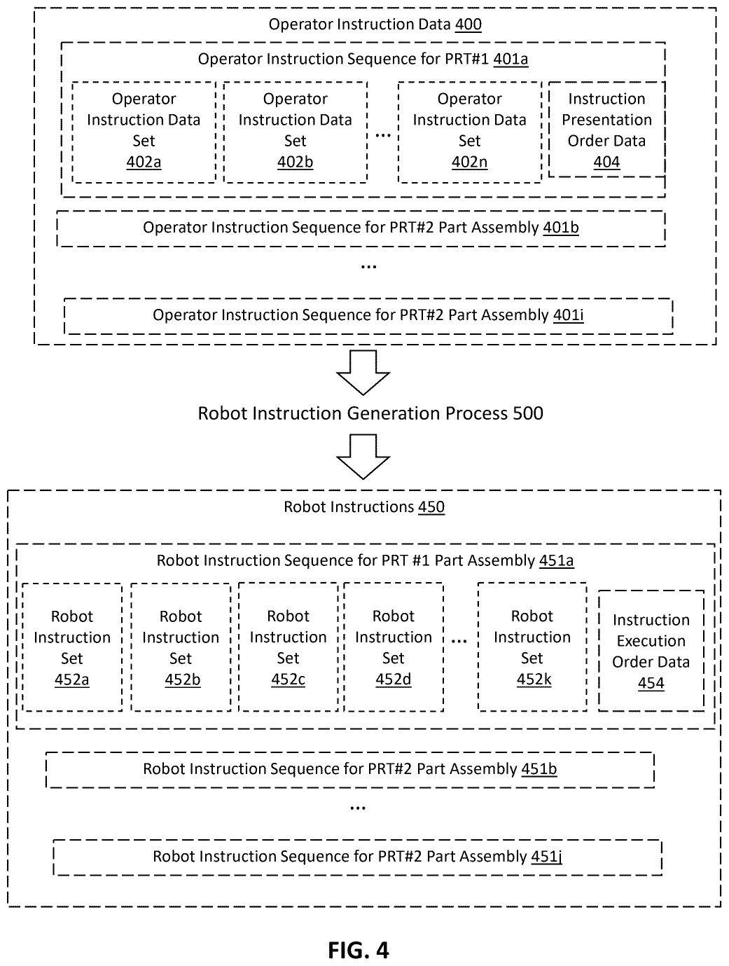

FIG. 4 shows the makeup of the operator instruction data 400 and robot instructions 450 in more detail. As shown, the operator instruction data 400 comprises several operator instruction sequences 401. In some examples, one or more (or each) of the operator instruction sequence 401 relates to the assembly of a particular part 110. While some of the operator instruction sequences 401 are shown with less detail than the operator instruction sequence 401a, it should be understood that this is just to preserve space and maintain simplicity rather than imply any other operator instruction sequence 401 comprises less data.

In the example of FIG. 4, each operator instruction sequence 401 comprises a plurality of operator instruction data sets 402. In some examples, each operator instruction data set 402 is representative of a set of operator instructions 202 specifying how or when to perform one or more welding-type operations of a part assembly. In some examples, the operator instruction data sets 402 may be output by the computing system 150 (as audiovisual (and/or otherwise human perceptible) instructions 202 (e.g., via computing I/O device(s) 154). For example, the first operator instruction data set 402a and second operator instruction data set 402b shown in FIG. 4 may be output as the first set of operator instructions 202a and second set of operator instruction 202b shown in FIG. 2.

In the example of FIG. 4, each operator instruction sequence 401 further comprises instruction presentation order data 404. In some examples, the instruction presentation order data 404 comprises machine readable data that specifies an order in which to present the operator instructions 202 represented by the operator instruction data sets 402 of the operator instruction sequence 401. For example, the instruction presentation order data 404 may specify to the computing system 150 that that the second set of operator instructions 202 of FIG. 2 should be presented before the third set of operator instructions 202, and after the first set of operator instructions 202. In some examples, some or all of the presentation order data 404 may instead be part of the operator instruction data sets 402 themselves.

In some examples, the robot instruction generation process 500 may comprise a process by which the computing system 150 performs an analysis of the operator instruction data 400 and generates robot instructions 450 based on the analysis. For example, the robot instruction generation process 500 may identify a particular operator instruction sequence 401, perform an analysis of each operator instruction data set 402 of the particular operator instruction sequence 401, and generate robot instructions 450 based on the analysis. In some examples, the analysis may involve parsing each operator instruction data set 402 to identify parameter values (e.g., weld start/end position, equipment settings, technique parameters, etc.). The robot instruction generation process 500 may then generate the robot instructions 450 based on the analysis.

FIG. 4 shows a more detailed example of the robot instructions 450. In the example of FIG. 4, the robot instructions 450 comprise several robot instructions sequences 451. In some examples, each robot instruction sequence 451 relates to the assembly of a particular part 110 (e.g., similar to each operator instruction sequence 401). While some of the robot instruction sequences 451 are shown with less detail than the robot instruction sequence 451a, it should be understood that this is just to preserve space and maintain simplicity rather than imply any other robot instruction sequence 451 comprises less data.

In the example of FIG. 4, each robot instruction sequence 451 comprises a plurality of robot instruction sets 452. In some examples, each robot instruction set 452 comprises machine readable instructions. In some examples, the machine readable instruction(s) may be read, processed, and/or executed by the robot 302 such that the robot 302 operates in accordance with the robot instruction set 452.

In some examples, each robot instruction set 452 may pertain to a (e.g., welding-type) operation of the robot 302 or an operation of a human operator 130. In some examples, the robot instruction set 452 may use a simple (e.g., boolean) variable to indicate whether the robot instruction set 452 pertains to an operation of the robot 302 or an operation of a human operator 130. In some examples, robot instruction sets 452 pertaining to an operation of the robot 302 may specify (i) that the robot instruction set 452 pertains to an operation of the robot 302, and/or (ii) how or when to perform a welding-type operation. In some examples, robot instruction sets 452 pertaining to an operation of the human operator 130 may specify (i) that the robot instruction set 452 pertains to an operation of the a human operator 130, and/or (ii) how, how long, and/or when to wait while the human operator 130 performs the operation.

For example, if the robot instruction sequence 451a was generated via the robot instruction generation process 500 based on the operator instruction sequence 401a, the first robot instruction set 452a of the robot instruction sequence 451a might pertain to a human operation, while the second robot instruction set 452b and third robot instructions set 452c might pertain to robot operations. The human operation might entail, for example, securing and/or clamping the workpiece(s) 112 to the work table 304 (e.g., as specified in the comments of the operator instructions 202a), while the robot operations might entail, for example, performing tack welds (e.g., using the parameters set forth in the first set of operator instructions 202a). In such an example, the first robot instruction set 452a may instruct the robot 302 to wait until the operator 130 finishes the human operation of securing and/or clamping the workpiece(s) 112 to the work table 304 before performing the tack weld robot operations.

In some examples, robot instruction sets 452 pertaining to human operations (and/or their robot instruction sequences 451) may specify conditions indicative of completion of the human operation, and/or conditions that must otherwise be met before the robot 302 continues with the rest of the robot instruction sequence 451. For example, the first robot instruction set 452a (and/or robot instruction sequence 451a) might specify conditions indicative of completion of the securing/clamping operation, and/or conditions that must otherwise be met before the robot 302 continues on with the rest of the robot instruction sequence 451a.

For example, the first robot instruction set 452a (and/or robot instruction sequence 451a) might specify that the robot 302 should wait until sensor data captured by the environment sensor(s) 316 and/or equipment sensor(s) 132 indicate that a clamp signal was received by the welding-type equipment 102a/b, and/or that the operator 130 is no longer proximate the work table 304. As another example, a different robot instruction set 452 (and/or robot instruction sequence 451) might specify that the robot 302 should wait until sensor data captured by the environment sensor(s) 316 and/or equipment sensor(s) 132 indicate that that the welding-type tool 104a/c is in the holster 199, that the wire feeder 116y has ceased feeding wire, and/or that the welding-type equipment 102a/b has stopped supplying gas and/or welding-type output power.

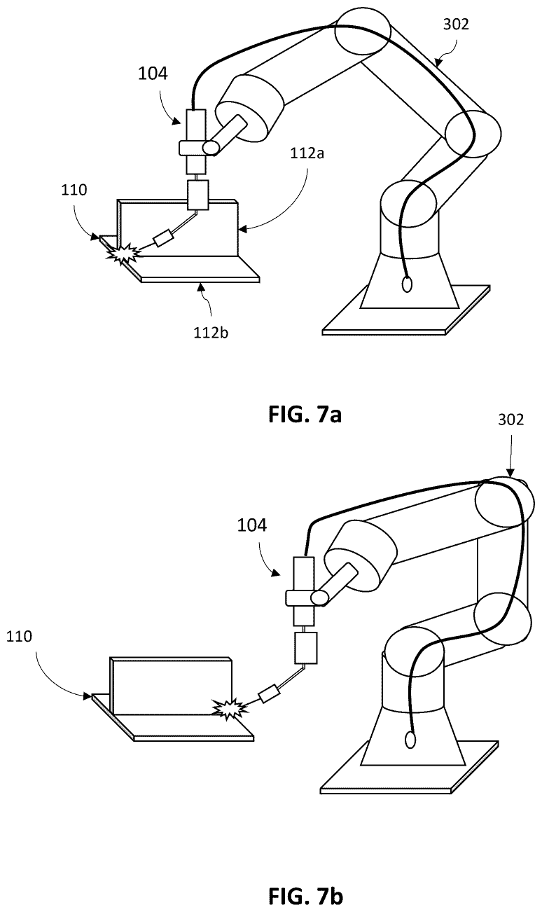

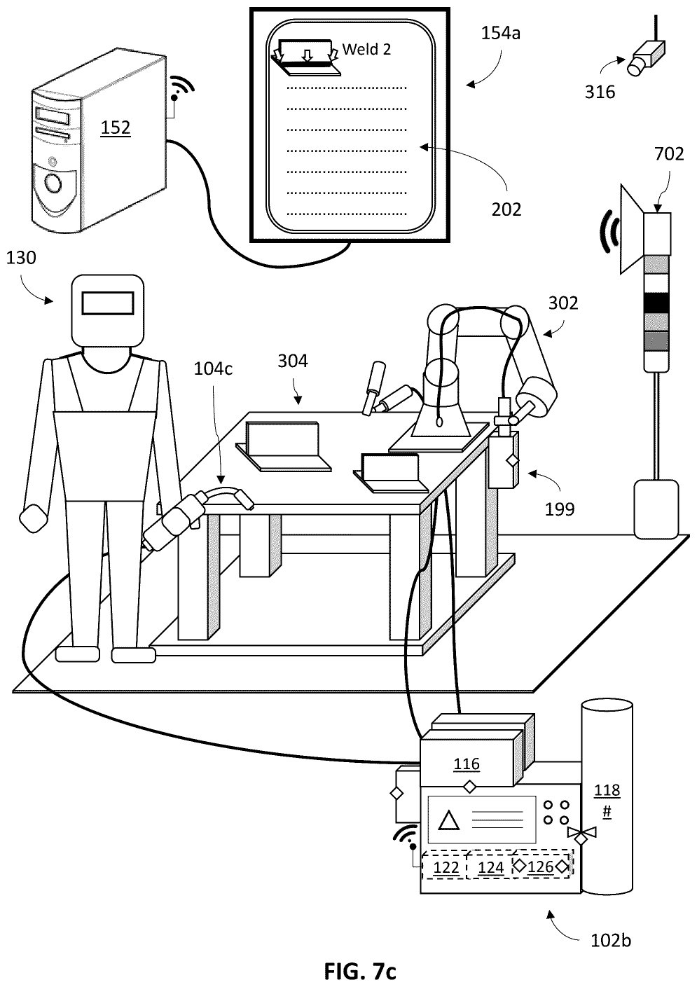

In some examples, the robot instruction sequence 451a might additionally, or alternatively, specify that the robot 302 should position itself and/or the welding-type tool 104b in a certain way and/or at a certain position/orientation while waiting for the operator 130 to finish the human operation. For example, the robot instruction sequence 451a might instruct the robot 302 to move the welding-type tool 104b away from the workpiece(s) 112 and/or into the tool holster 199 while waiting (see, e.g., FIG. 7c).

In the example of FIG. 4, each robot instruction sequence 451 also comprises instruction execution order data 454. In some examples, the instruction execution order data 454 comprises machine readable data that specifies an order in which to execute the robot instructions 450 of the robot instruction sequence 451. For example, the instruction execution order data 454 may specify that that the second robot instruction set 452b should be executed before the third robot instruction set 452c, and after the first robot instruction set 452a.

In some examples, some or all of the execution order data 454 may instead be part of the robot instruction data sets 452 themselves. In some examples, the execution order data 454 may additionally, or alternatively, specify which welding-type operations should be performed by the robot 302 and/or which operations should be performed by the human operator 130 (e.g., while the robot 302 waits).

In some examples, the robot instruction generation process 500 may generate the instruction execution order data 454 based on an analysis of the instruction presentation order data 404 of the particular operator instruction sequence 401. In some examples, an operator 130 may modify the instruction execution order data 454 and/or one or more robot instruction sets 452 after the robot instructions 450 are generated (e.g., to change the execution order and/or switch between robot/human operations). In some examples, the robot instruction execution process 600 may execute the robot instruction sets 452 of a particular robot instruction sequence 451 in the order specified by the instruction execution order data 454.

The automatic generation of robot instructions 450 via the robot instruction generation process 500 has the potential to save substantial time and energy that would otherwise have to be invested by robot programmers and/or welding experts to manually generate the robot instructions 450. Additionally, because substantial time and/or effort has often been spent honing and/or improving the human perceptible operator instructions 202 to ensure the human operator 130 executes the welding-type operations efficiently and/or effectively, robot execution of robot instructions 450 generated based on the operator instructions 202 is likely to result in similarly efficient and/or effective welding-type operations and/or part assembly. Furthermore, the ability of the robotic welding-type system 300 to accommodate contributions of the human operator 130 during both the robot instruction generation process 500 and the robot instruction execution process 600 increases the potential for collaboration between the robot 302 and the human operator 130.

In some examples, the robot instruction generation process 500 and/or robot instruction execution process 600 may comprise machine readable instructions configured for execution by the computing processing circuitry 168 and/or robot processing circuitry 368. In some examples, the computing memory circuitry 162 and/or robot memory circuitry 362 may further include (and/or store) certain parameters and/or thresholds used in the robot instruction generation process 500 and/or robot instruction execution process 600. In some examples, the parameters and/or thresholds may also be considered part of the robot instruction generation process 500 and/or robot instruction execution process 600.

FIG. 5 is a flowchart showing an example of the robot instruction generation process 500. While the robot instruction generation process 500 and/or robot instruction execution process 600 is sometimes described below as conducting certain actions for the sake of understanding, it should be understood that one or more of the above described components of the robotic welding-type system 300 (e.g., the computing processing circuitry 168, computing I/O device(s) 154, pendant 310, robot processing circuitry 368, etc.) may undertake the actions on behalf of (and/or according to) the robot instruction generation process 500 and/or robot instruction execution process 600.

In the example of FIG. 5, the robot instruction generation process 500 begins at block 502, where a particular operator instruction sequence 401 is identified. In some examples, the identification may be based on user input (e.g., received via the computing I/O device(s) 154). In some examples, the identification may be based on sensor data detected by the environment sensor(s) 316 (e.g., relating to a particular arrangement of workpieces 112, a barcode, etc.).

After a particular operator instruction sequence 401 is identified at block 502, the robot instruction generation process 500 proceeds to block 503. At block 503, the robot instruction generation process 500 determines which welding-type operations (and/or other operations) of the operator instruction sequence 401 should be done by the robot 302, and which should still be done by an operator 130. In some examples, at block 503, the robot instruction generation process 500 additionally, or alternatively, determines which operator instructions 202 and/or operator instruction data sets 404 should be “translated” into robot instructions 450 to be performed by the robot 302, and which should be omitted from such translation.

In some examples, the determination at block 503 is based upon input from the operator 130 (e.g., received via the computing I/O device(s) 154). In some examples, the determination at block 503 is based upon data stored in computing memory circuitry 162 (e.g., previously provided by the operator 130 and/or some other source). In some examples, the determination may default to using all of the operator instruction data sets 404 of the operator instruction sequence 401. In some examples, the results of the determination(s) at block 503 may be saved to, and/or stored via, the computing memory circuitry 162.

After block 503, the robot instruction generation process 500 next proceeds to block 504 where an analysis of the instruction presentation order data 404 is performed. In some examples, the analysis may entail an examination of the instruction presentation order data 404 to determine a presentation order of the set of operator instructions 202 represented by the various operator instruction data sets 402. Using this analysis, the robot instruction generation process 500 then identifies, a first operator instruction data set 402 of the plurality of operator instruction data sets 402 that make up the operator instruction sequence 401.

After identifying the first operator instruction data set 402 at block 504, the robot instruction generation process 500 next determines at block 505 whether (e.g., at least some of) the identified operator instruction data set 402 should be used to generate robot instructions 450. In some examples, this determination is based on the determination(s) of block 503. If none of the identified operator instruction data set 402 is to be used to generate robot instructions 450, then the robot instruction generation process 500 proceeds to block 512, discussed below.

If at least some of the identified operator instruction data set 402 is to be used to generate robot instructions 450, then the robot instruction generation process 500 next performs an analysis of the identified operator instruction data set 402 at block 506. In some examples, the analysis may entail an examination of the operator instruction data set 402 to determine how many welding-type operations are called for by the operator instruction data set 402. In some examples, this examination may include parsing the set of operator instructions 202 represented by the operator instruction data set 402 to find parameter values, comment keywords/phrases, and/or annotations in the visual depiction(s) 204 that indicate how many welding-type operations are called for by the first operator instruction data set 402. In some examples, one or more large language models, neural networks, natural language processing techniques, machine learning techniques, computer vision techniques, and/or image processing techniques may be used in this endeavor.

In some examples, at block 506, the robot instruction generation process 500 additionally examines the operator instruction data set 402 (and/or represented operator instructions 202) to identify parameter values to employ in the execution of each welding-type operation. In some examples, this identification may include parsing the set of operator instructions 202 represented by the operator instruction data set 402 to find parameters values. In some examples, one or more large language models, neural networks, natural language processing techniques, machine learning techniques, computer vision techniques, and/or image processing techniques may be used in this endeavor.

After identifying the welding-type operation(s) and/or parameter value(s) at block 506, the robot instruction generation process 500 proceeds to block 505. At block 505, the robot instruction generation process 500 determines whether the identified operator instruction data set 402 calls for one or more operations for which the robot 302 may be poorly suited.

For example, the robot 302 may only be suited for performing welding-type operations and, in some examples, no welding-type operation may be called for by the operator instruction data set 402. Instead the operator instructions 202 represented by the operator instruction data set 402 might relate to other aspects of a part assembly besides welding-type operations (e.g., making sure a clamp 108 is secure, checking a welding-type tool 104, arranging equipment, viewing an instructional video, etc.). In such examples, a human operator 130 may be considered better suited for the operation(s) than the robot 302.

As another example, the robot 302 might be considered poorly suited to perform welding-type operations with certain requirements. For instance, the robot 302 might be considered poorly suited to perform welding-type operations that require multiple overlapping passes over the same area, or require operating with the welding-type tool 104b and/or workpieces 112 in certain positions and/or orientations (e.g., overhead, vertical, etc.). If the identified operator instruction data set 402 calls for one or more non-welding-type operations, or one or more welding-type operations with requirements that are poorly suited for execution by the robot 302, the robot instruction generation process 500 may determine at block 507 that the robot 302 would not be suited to perform the operation(s).

In some examples, the robot instruction generation process 500 determines whether the identified operator instruction data set 402 calls for one or more welding-type operations for which the robot 302 may be suited based on the parameter values identified at block 506. In some examples, the robot instruction generation process 500 outputs a recommendation regarding suitability (e.g., via the I/O device(s) 154) and relies upon input from the operator 130 (e.g., via the I/O device(s) 154) for the ultimate decision regarding suitability. To the extent the robot instruction generation process 500 determines there are no welding-type operations called for by the operator instruction data set 402 for which the robot 302 is suited, the robot instruction generation process 500 proceeds to block 512, discussed below.

If the robot instruction generation process 500 determines there is at least one welding-type operation suitable for the robot 302 that is called for by the operator instruction data set 402, the robot instruction generation process 500 proceeds to block 510. At block 510 the robot instruction generation process 500 attempts to correlate one or more real world positions and/or orientations with one or more of the identified parameter positions/orientations.

In some examples, this correlation attempt involves an analysis of sensor data captured by the environment sensor(s) 316 and/or robot position sensor(s) 308. For example, if one or more of the workpiece(s) 112 have been positioned proximate where they would be if the human operator 130 were to execute the corresponding welding-type operation(s), the environment sensor(s) 316 and/or robot position sensor(s) 308 may capture sensor data that can be analyzed to identified real world positions and/or orientations (e.g., relative to the robot 302 position/orientation) that correspond to identified position and/or orientation parameter values.

In examples where the sensor data comprises image data, the analysis may use computer vision and/or other image processing techniques to identify the real-world positions and/or orientations. In some examples, the real-world positions and/or orientations may be represented in the form of point coordinate, angle, and/or vector information.

In the example of FIG. 5, the robot instruction generation process 500 next proceeds to block 510 where the robot instruction generation process 500 generates robot instructions 450 for the welding-type operation(s) suitable for the robot 302. In some examples, the generated robot instructions 450 are instructions for the robot 302 to follow and/or execute to perform the welding-type operation(s) suitable for the robot 302. In some examples, the robot instruction generation process 500 generates the robot instructions 450 based on the welding-type operations, parameters, and/or real-world positions/orientations identified at blocks 508 and 510. In some examples, block 510 may entail generating a new robot instruction sequence 451 if no appropriate robot instruction sequence 451 yet exists.

In some examples, block 510 may further entail generating one or more new robot instruction sets 452 of the robot instruction sequence 451 based on the parameter values and/or real world positions/orientations identified at blocks 508 and 510. In some examples, a new robot instruction set 452 may be generated for each identified welding-type operation. To the extent more than one robot instruction set 452 is generated (e.g., one for each of the more than one identified welding-type operation), the robot instruction generation process 500 may determine the execution order of the robot instruction set 452 based on analysis of the operator instruction set 402.

After block 510, the robot instruction generation process 500 proceeds to block 511 where the robot instruction generation process 500 determines whether the operator instruction data set 402 calls for one or more operations that should be performed by the human operator 130. In some examples, this determination may be based on the analysis and/or outcomes of blocks 505 and 507. For example, the robot instruction generation process 500 may determine at block 505 or 507 that the identified operator instruction data set 402 relates to both a welding-type operation that should be performed by the robot 302, and an additional operation that should be performed by a human operator 130. If the operator instruction data set 402 does call for one or more operations that should be performed by the human operator 130, the robot instruction generation process 500 proceeds to block 512.

At block 512, the robot instruction generation process 500 generates robot instructions 450 indicating that one or more human operations are to be performed. In some examples, block 512 may entail generating a new robot instruction sequence 451 if no appropriate robot instruction sequence 451 yet exists. In some examples, block 512 may further entail generating one or more new robot instruction sets 452 of the robot instruction sequence 451.

In some examples, the robot instructions 450 generated at block 512 may instruct the robot 302 to delay performance of further welding-type operations (and/or execution of further robot instruction sets 452) until a human operator 130 completes performance of the one or more human operations. In some examples, the robot instructions 450 may indicate that the human operation(s) should be deemed completed when the human operator 130 provides some input to that effect (e.g., via the computing I/O device(s) 154). In some examples, the robot instructions 450 may indicate that the human operation(s) should be assumed to be completed after a certain amount of time has passed. In some examples, the robot instruction generation process 500 may determine the specific amount of time to wait based on the type(s) and/or parameter(s) of the human operation(s).

In some examples, the robot instructions 450 may indicate that sensor data captured by the environment sensor(s) 316 should be used to determine when performance of the human operation(s) has been completed. For example, the performance of the human operation(s) may be determined to be completed when one or more environment sensors 316 capture sensor data indicating that a welding-type operation has ceased (e.g., given the dramatically lower levels and/or decrease in heat, fumes, light, etc.). As another example, the performance of the human operation(s) may be determined to be completed when one or more environment sensors 316 capture sensor data indicating that the welding-type tool 104a and/or welding-type tool 104c has been placed in its holster 199, or the welding-type tool 104b has been reattached to the robot 130. As another example, the performance of the human operation(s) may be determined to be completed when one or more environment sensors 316 capture sensor data indicating that the operator 130 is no longer standing on the floor mat, no longer in the operation area, and/or in one or more designated non-operational areas.

In some examples, the robot instructions 450 may indicate that sensor data captured by the equipment sensor(s) 132 should be used to determine when performance of the human operation(s) has been completed. For example, the performance of the human operation(s) may be determined to be completed when one or more equipment sensors 132 capture sensor data indicating that the welding-type tool 104a and/or welding-type tool 104c has been placed in its holster 199. As another example, the performance of the human operation(s) may be determined to be completed when the equipment sensor(s) 132 capture sensor data indicating that there has been a dramatic decrease in the output(s) of the welding-type equipment 102a and/or 102b (e.g., current, voltage, wire, gas, etc.), and/or the output(s) are at a below threshold level (and/or have been for a threshold amount of time). As another example, the performance of the human operation(s) may be determined to be completed when the equipment sensor(s) 132 capture sensor data indicating that there has been a dramatic decrease in the wire feed speed and/or wire output of the particular wire feeder 116y used by the human operator 130, and/or the wire feed speed and/or wire output is at a below threshold level (and/or has been for a threshold amount of time).

In some examples, the generated robot instructions 450 may specify that the robot 302 should move itself and/or the welding-type tool 104b to a position and/or orientation remote from the workpiece(s) 112 and/or human operation(s) while waiting for the human operation(s) to be completed. In some examples, the remote position/orientation may be a position/orientation where the potential for interference with the human operation(s) is reduced and/or minimized. For example, a position and/or orientation where at least a portion or a majority of the welding-type tool 104b is positioned within a tool holster 199. In some examples, the particular position and/or orientation may be determined based on identified type(s) and/or parameter value(s) of the human operation(s).

In some examples, the generated robot instructions 450 may specify that the robot 302, computing I/O device(s) 154, welding-type equipment 102, and/or some other device should provide a human perceptible output when the robot 302 and/or welding-type tool 104b is remotely positioned/oriented. The human perceptible output might be, for example, one or more (e.g., flashing/static/differently colored) lights, (e.g., alarm, chiming, etc.) sounds, and/or vibrations. In some examples, this output may indicate to the operator 130 that the robot 302 and/or welding-type tool 104b is correctly positioned for the human operation(s).

In the example of FIG. 5, once the robot instructions 450 are generated, the robot instruction generation process 500 proceeds to block 513 where the robot instructions 450 are stored in computing memory circuitry 162 and/or transmitted to the robot 302 (e.g., for storage in the robot memory circuitry 362). As shown, the robot instruction generation process 500 loops through blocks 505-513 for each operator instruction data set 402 in the identified operator instruction sequence 401.

At block 514, the robot instruction generation process 500 examines the operator instruction sequence 401 (and/or its presentation order data 404) to determine whether there exist other operator instruction data sets 402 that have yet to be analyzed. If so, the robot instruction generation process 500 identifies the next operator instruction data set 402 of the operator instruction sequence 401 at block 516 (e.g., as specified by the presentation order data 404), then returns to block 505 to begin the block 505-513 loop anew.

Once all the operator instruction data sets 402 have been processed, the robot instruction generation process 500 generates instruction execution order data 454 at block 518. In some examples, the instruction execution order data 454 specifies an order in which the robot instruction sets 452 should be executed. In some examples, the instruction execution order data 454 further specifies which of the robot instruction sets 452 pertain to robot operations, and/or which of the robot instruction sets 452 pertain to human operations. In some examples, the instruction execution order data 454 is generated based on the presentation order data 404 and/or the order in which the robot instruction sets 452 were generated.

While shown as being outside the block 505-512 loop in the example of FIG. 5, in some examples, block 518 may alternatively, or additionally, be executed within (e.g., at the end of) the loop, such that the instruction execution order data 454 is continuously and/or iteratively generated as the robot instruction sets 452 are generated. After all the robot instruction sets 452 and the instruction execution order data 454 has been generated, the robot instruction generation process 500 proceeds to block 520 where the generated robot instruction sequence 451 is stored in computing memory circuitry 162 and/or transmitted to the robot 302 (e.g., for storage in the robot memory circuitry 362).

In some examples, the robot instruction generation process 500 also saves and/or transmits a record of (and/or reference to) the operator instruction sequence 401 that was used to generate the robot instruction sequence 451. In some examples, the robot instruction generation process 500 also saves a record of (and/or reference to) the operator instruction data set 402 used to generate each robot instruction set 452. In some examples, the record and/or reference information may be saved as a whole or in part as part of the execution order data 454, robot instruction sequence 451, and/or as part of each individual robot instruction set 452.

In some examples, the record and/or reference information may be used during the robot instruction execution process 600. For example, when executing the robot instructions 450 instructing the robot 302 to wait while a human operation is performed, the robot instruction execution process 600 may output the operator instructions 202 pertaining to the human operation (e.g., via the computing I/O device(s) 154). Thus, while the robot instruction execution process 600 is shown in FIG. 3b as being part of the robot controller 350, in some examples, some or all of the robot instruction execution process 600 may additionally, or alternatively, be stored in computing memory circuitry 162, and/or executed by computing processing circuitry 168.

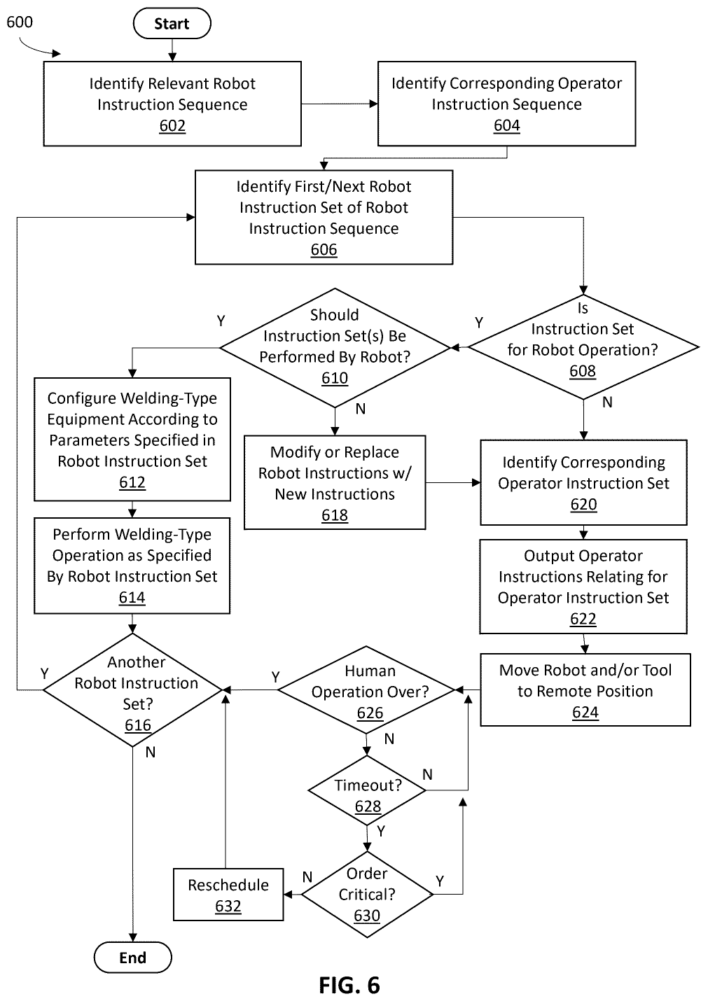

FIG. 6 is a flowchart showing an example of the robot instruction execution process 600. In some examples, the robot instruction execution process 600 may execute in response to input from a human operator 130 (e.g., received via the pendant 310, computing I/O device(s) 154, and/or robot interface 312). In some examples, the robot instruction execution process 600 may execute in response to programmatic and/or signal input.

As shown, the robot instruction execution process 600 begins at block 602, where a particular robot instruction sequence 451 is identified. In some examples, the identification may be based on user input (e.g., received via the computing I/O device(s) 154). In some examples, the identification may be based on sensor data detected by the environment sensor(s) 316 (e.g., relating to a particular arrangement of workpieces 112, a barcode, etc.).

After a particular robot instruction sequence 451 is identified at block 602, the robot instruction execution process 600 proceeds to block 604 where a corresponding operator instruction sequence 401 is identified. In some examples, the robot instruction generation process 500 may have previously saved a reference to the operator instruction sequence 451 corresponding to each robot instruction sequence 451, and block 604 may reference this information. In some examples where no such reference information is available, the robot instruction execution process 600 may search for information in various operator instruction sequences 401 that is similar to the identified robot instruction sequence 451 (e.g., similar type/identifier of the part 110 to be assembled, similar number of instruction sets, similar parameters, etc.).

Once the operator instruction sequence 451 is identified, the robot instruction execution process 600 proceeds to block 606 where the robot instruction execution process 600 identifies the first (and/or next) robot instruction set 452 to be executed in the identified robot instruction sequence 451. In some examples, this identification may rely on the execution order of robot instruction sets 452 specified by the execution order data 454. Afterwards, the robot instruction execution process 600 proceeds to block 608 where the robot instruction execution process 600 determines whether the identified robot instruction set 452 relates to a robot operation to be performed by the robot 302, or a human operation to be performed by the human operator 130.

In some examples, the robot instruction execution process 600 may base the determination at block 608 on the information encoded in the robot instruction set 452, the execution order data 454, and/or the rest of the robot instruction sequence 451. If the robot instruction execution process 600 determines that the robot instruction set 452 relates to a human operation of the human operator 130, the robot instruction execution process 600 proceeds to block 620, further discussed below.

If the robot instruction execution process 600 determines that the robot instruction set 452 relates to a robot operation to be performed by the robot 302, the robot instruction execution process 600 subsequently determines, at block 610, whether there are any issues with the robot operation that might make it more suitable for performance by the human operator 130. In some examples, the human operator 130 may provide an input (e.g., via the computing I/O device(s) 154) indicating that the operation is more suitable for the human operator 130. For example, the human operator 130 may notice an issue with the fitup and/or positioning of the workpieces 112, or an issue with a prior operation. In such an example, the human operator 130 may determine that it would be better for the human operator 130 to perform the operation, and provide an input to that effect, in which case the robot instruction execution process 600 proceeds to block 618, further discussed below.

In some examples, the robot instruction execution process 600 may automatically determine that the robot operation would be better performed by a human operator 130. For example, the robot instruction execution process 600 may determine that sensor data captured by the environment sensor(s) 316 indicate there is an issue with the fitup and/or positioning of the workpieces 112, or an issue with a prior operation. In such an example, the robot instruction execution process 600 may determine that it would be better for the human operator 130 to perform the operation, despite the operation being initially designated for the robot 302 to perform.

In some examples, if the robot instruction execution process 600 determines that a human operator 130 would be better suited to perform the operation to which the robot instruction set 452 relates at block 610, the robot instruction execution process 600 may provide a recommendation to that effect (e.g., via the computing I/O device(s) 154). If the human operator 130 subsequently accepts the recommendation, the robot instruction execution process 600 proceeds to block 618, discussed further below. In some examples, the robot instruction execution process 600 may assume acceptance of the recommendation if no input is received after a threshold time, or automatically proceed to block 618 (discussed below) without bothering to make the recommendation first.

If, instead, the robot instruction execution process 600 determines at blocks 608-610 that the robot instruction set 452 relates to a welding-type operation that the robot 130 is suited to perform, the robot instruction execution process 600 proceeds to block 612, where the robot instruction execution process 600 sends one or more command signals to the welding-type equipment 102. In some examples, the command signal(s) command the welding-type equipment 102 to configure the welding-type equipment 102 according to the welding parameters and/or equipment parameters specified by the robot instruction set 452.

After block 612, the robot instruction execution process 600 proceeds to block 614 where the robot instruction execution process 600 commands the robot 302 to perform the welding-type operation according to the welding parameters and/or technique parameters specified by the robot instruction set 452. In some examples, having the robot 302 perform the welding-type operation may involve moving the welding-type tool 104 to an appropriate start position via the robot manipulator 306 and sending one or more activation signals to the welding-type equipment 102 to activate output of welding-type power and/or consumables. Having the robot 302 perform the welding-type operation may additionally, or alternatively, involve moving the welding-type tool 104, via the robot manipulator 306, along an operation path, towards an end point, in accordance with the technique parameters specified by the robot instruction set 452. Robot 302 performance of the welding-type operation may additionally, or alternatively, involve, stopping the welding-type tool 102 at an appropriate end position, and/or sending one or more deactivation signals to the welding-type tool 102 when the welding-type tool 102 is at the appropriate end position (and/or ceasing transmission of the activation signal(s)).

If the robot instruction execution process 600 determines at block 610 that a human operator 130 would be better suited to perform the operation to which the robot instruction set 452 relates, then the robot instruction execution process 600 proceeds to block 618. At block 618, the robot instruction execution process 600 modifies or replaces some or all of the robot instructions 450 of the robot instruction set 452, and/or the robot instructions 450 of the execution order data 454, to reflect the fact that a human operator 130 will be performing the welding-type operation instead of the robot 302. In some examples, block 618 may involve the generation of new robot instructions 450 (e.g., to supersede or replace the old robot instructions 450). In some examples, the generation of the new robot instructions 450 may be similar to block 510 of the robot instruction generation process 500 discussed above, except that the parameter values may be taken from the robot instruction set 452 rather than the operator instruction data set 402.

After block 618, and/or if the robot instruction execution process 600 determines at block 608 that the robot instruction set 452 relates to a human operation to be performed by the human operator 130, the robot instruction execution process 600 proceeds to block 620. At block 620, the robot instruction execution process 600 identifies the corresponding operator instruction data set 402, using similar techniques as described above with respect to block 604. After identifying the relevant operator instruction data set 402, the robot instruction execution process 600 proceeds to block 622, where the robot instruction execution process 600 outputs (e.g., via the computing I/O device(s) 154) the set of operator instructions 202 represented by the identified operator instruction data set 402, so that the human operator 130 can follow the operator instructions 202 and complete the human operation.

In some examples, the operator instruction data set 402 may be sent by and/or received from the computing device 152 at block 610 (e.g., in response to one or more requests). In some examples, the operator instruction data set 402 may be stored as part of the robot instruction set 452. While shown as occurring before block 624, in some examples, block 622 may occur at approximately the same time as, and/or in synchronization with, block 624.

In the example of FIG. 6, after block 622, the robot instruction execution process 600 proceeds to block 624, where the robot instruction execution process 600 moves the robot 302 and/or welding-type tool 104b to a position and/or orientation out of the way of the human operator 130 and/or human operation. In some examples, the movement is in accordance with the robot instructions 450 in the robot instruction sequence 451, robot instruction set 452, and/or robot instruction execution order data 454, and/or generated by the robot instruction generation process 500, as discussed above with respect to block 512. In some examples, robot instruction execution process 600 may provide some human perceptible output when the robot 302 and/or welding-type tool 104b is out of the way, so that the operator 130 knows it is time to perform the human operation(s).

After moving the robot 302 and/or welding-type tool 104b out of the way at block 624, the robot instruction execution process 600 proceeds to block 626, where the robot instruction execution process 600 determines whether the human operation has completed. In some examples, the determination is in accordance with the robot instructions 450 in the robot instruction sequence 451, robot instruction set 452, and/or robot instruction execution order data 454, and/or generated by the robot instruction generation process 500, as discussed above with respect to block 512. In some examples, this determination may be based on an amount of time passed, input from the operator 130 (e.g., via the I/O device(s) 154), input from the welding-type equipment 102 (e.g., arc on/off signal(s)), input from the environment sensor(s) 316, and/or input from the equipment sensor(s) 132, as discussed above with respect to block 512.

If the human operation is determined to be completed at block 626, the robot instruction execution process 600 proceeds to block 616, further discussed below. If the robot instruction execution process 600 determines the human operation is not yet completed at block 626, the robot instruction execution process 600 proceeds to block 628.

At block 628, the robot instruction execution process 600 determines whether a threshold amount of time has passed. In some examples, the robot instruction execution process 600 may additionally, or alternatively, determine whether the human operator 130 is elsewhere and/or involved in a different part assembly process (e.g., via analysis of sensor data captured by the environment sensor(s) 316 and/or equipment sensor(s) 132). If not, the robot instruction execution process 600 returns to block 626. If so, the robot instruction execution process 600 proceeds to block 630, where the robot instruction execution process 600 determines whether it is critical that the human operation be performed exactly at this point in the robot instruction sequence 451.

If it is critical that the human operation be performed exactly at this point in the robot instruction sequence 451, the robot instruction execution process 600 returns to block 626. If it is not critical that the human operation be performed exactly at this point in the robot instruction sequence 451, the robot instruction execution process 600 attempts to reschedule the human operation at block 632.

In some examples, the criticality of the ordering of the human operation may be determined based on the parameters identified in the robot instruction set 452, and/or other information in the robot instruction sequence 451. In some examples, the rescheduling may entail modifying the execution order data 454 so that the current robot instruction set 452 is scheduled for execution later in the robot instruction sequence 451. After the rescheduling at block 632, the robot instruction execution process 600 proceeds to block 616.

In the example of FIG. 6, the robot instruction execution process 600 also proceeds to block 616 after block 614 and/or after block 626 (if/when the human operation is determined to be over). At block 616, the robot instruction execution process 600 examines the execution order data 454 to determine whether there exist other robot instruction sets 452 of the robot instruction sequence 451 that have yet to be executed. If so, the robot instruction execution process 600 selects the next robot instruction set 452 of the robot instruction sequence 451 at block 606 (e.g., as specified by the execution order data 454), then returns to block 608 to begin again. Once all the robot instruction sets 452 of the robot instruction sequence 451 have been executed, the robot instruction execution process 600 ends.

FIGS. 7a-7b show examples of the robot 302 performing welding-type operations according to a robot instruction sequence 451 (e.g., the PRT #1 robot instruction sequence 451a). FIG. 7c further shows the robot 302 moved to a remote out of the way position/orientation when a human operation is being performed, and a corresponding sets of operator instructions 202 being output via the display screen computing I/O device 154a at the same time.

In FIG. 7a the robot 302 is performing a first welding-type operation (e.g., a first tack weld) at the start position identified in the operation instructions 202a. In some examples, this welding-type operation might be performed according to a second robot instruction set 452b of the robot instruction sequence 451a.

In FIG. 7b, the robot 302 is performing a second welding-type operation (e.g., a second tack weld) at the end position identified in the operation instruction 202a. In some examples, this welding-type operation might be performed according to a third robot instruction set 452c of the robot instruction sequence 451a.

In FIG. 7c, the robot 302 is shown with the welding-type tool 104b in the holster 199 during a human operation, so as to avoid interference with the human operator 130 and/or the human operation. An output device 702 (e.g., light stack, speaker, etc.) is shown providing one or more human perceptible outputs to indicate to the human operator 130 that the robot 302 and/or welding-type tool 104b has been moved out of the way (e.g., in response to a command from the robot instruction execution process 600 and/or in direct response to sensor data captured by one of the sensors). Meanwhile, the human operator 130 is shown holding the welding-type tool 104c proximate the work table 304 and ready to begin a manual (e.g., human) welding-type operation. A corresponding set of operator instructions 202 is output via the display screen computing I/O device 154a to guide the human operator 130 through the manual (e.g., human) welding-type operation.

The present disclosure contemplates robot welding sequences 451 that anticipate and/or accommodate interleaved human operations. In some examples, the robot instructions 450 of a robot welding sequence 451 instruct the robot 302 to pause execution of the robot welding sequence 451, and/or move the welding-type tool 102b attached to the robot 302 to some out of the way position/orientation, while the human operator 130 performs the human operation(s). The ability of the robot instruction generation process 500 and/or robot instruction execution process 600 to accommodate and/or anticipate intervening participation of a human operator 130 during a part assembly process opens up numerous possibilities for increased human/robot collaboration.

The present methods and/or systems may be realized in hardware, software, or a combination of hardware and software. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein, “human perceptible” refers to the ability of a human to detect, recognize, discern, understand and/or become aware of information through the use of a sensory organ of the human body (e.g., an ear, eye, tongue, nose, hand, etc.).

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, control circuitry may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, processing circuitry means processing devices, apparatus, programs, circuits, components, systems, and subsystems, whether implemented in hardware, tangibly embodied software, or both, and whether or not it is programmable. The term “processing circuitry” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processing circuitry may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processing circuitry may be coupled to, and/or integrated with a memory device.

As used, herein, the term “memory” and/or “memory circuitry” means computer hardware or circuitry to store information for use by a processor and/or other device. The memory and/or memory circuitry can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type refers to welding (including laser welding and/or hot wire welding), cladding (including laser cladding), brazing, plasma cutting, induction heating, carbon arc cutting or gouging, hot wire preheating, and/or resistive preheating.

As used herein, a welding-type tool refers to a tool suitable for and/or capable of welding (including laser welding and/or hot wire welding), cladding (including laser cladding), brazing, plasma cutting, induction heating, carbon arc cutting or gouging, hot wire preheating, and/or resistive preheating.

As used herein, welding-type power refers to power suitable for welding (including laser welding and/or hot wire welding), cladding (including laser cladding), brazing, plasma cutting, induction heating, carbon arc cutting or gouging, hot wire preheating, and/or resistive preheating.

As used herein, a welding-type power supply and/or welding-type power source refers to a device capable of, when input power is applied thereto, supplying output power suitable for welding (including laser welding and/or hot wire welding), cladding (including laser cladding), brazing, plasma cutting, induction heating, carbon arc cutting or gouging, hot wire preheating, and/or resistive preheating; including but not limited to transformer-rectifiers, inverters, converters, resonant power supplies, quasi-resonant power supplies, switch-mode power supplies, etc., as well as control circuitry and other ancillary circuitry associated therewith.

As used herein, a welding-type operation refers to an operation where an electrical current, electrical arc, laser, plasma, or magnetic field is produced using a welding-type tool and/or welding-type power, and/or such an output is directed towards a workpiece.

As used herein, disable may mean deactivate, incapacitate, and/or make inoperative. As used herein, enable may mean activate and/or make operational.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. A welding system, comprising:
a robot comprising a robotic manipulator;
a welding-type tool coupled to the robotic manipulator;
memory circuitry storing a plurality of machine readable robot instructions relating to performance of a plurality of welding-type operations; and
processing circuitry configured to:
identify one or more machine readable robot instructions, from the plurality of machine readable robot instructions, that are associated with a particular welding-type operation of the plurality of welding-type operations,
determine, based on the one or more machine readable robot instructions, whether the particular welding-type operation is to be performed by the robot or performed by a human operator,
in response to determining the particular welding-type operation is to be performed by the human operator, determine when or whether the human operator has completed performance of the particular welding-type operation, and
in response to determining the human operator has completed performance of the particular welding-type operation, identify one or more subsequent machine readable robot instructions, of the plurality of machine readable robot instructions, that are associated with a subsequent welding-type operation of the plurality of welding-type operations, the subsequent welding-type operation to be performed directly subsequent to the particular welding-type operation.

2. The welding system of claim 1, wherein the processing circuitry is configured to determine when or whether the human operator completed performance of the welding-type operation based on one or more signals received from: a user interface (UI), welding-type equipment, or a sensor.

3. The welding system of claim 2, wherein the sensor comprises a robot sensor configured to detect when the welding-type tool is attached to or detached from the robotic manipulator, an operator sensor configured to track a position or orientation of the human operator, or an environment sensor configured to monitor an environmental condition of a surrounding environment.

4. The welding system of claim 1, wherein the processing circuitry is further configured to move the robotic manipulator or the welding-type tool to a remote position away from the particular welding-type operation in response to determining the particular welding-type operation is to be performed by the human operator.

5. The welding system of claim 1, wherein the processing circuitry is further configured to:
in response to determining the particular welding-type operation is to be performed by the human operator, output, via a user interface, one or more human perceptible instructions relating to performance of the welding-type operation by the human operator.

6. The welding system of claim 1, wherein the processing circuitry is further configured to:
in response to determining the particular welding-type operation is to be performed by the human operator, and a threshold time passing without being able to determine that the human operator has completed performance of the particular welding-type operation:
identify the one or more subsequent machine readable robot instructions that are associated with the subsequent welding-type operation, and
reschedule the particular welding-type operation to be performed after the subsequent welding-type operation.

7. The welding system of claim 1, wherein the processing circuitry is further configured to:
determine, based on the one or more subsequent machine readable robot instructions, whether the subsequent welding-type operation is to be performed by the robot or performed by the human operator,
in response to determining the subsequent welding-type operation is to be performed by the robot, move the robotic manipulator in a subsequent robot movement pattern defined by the one or more subsequent machine readable robot instructions, and
command a piece of welding-type equipment connected to the welding-type tool to output welding-type power, welding wire, or shielding gas to the welding-type tool during movement of the robotic manipulator in the subsequent robot movement pattern.

8. A welding system, comprising:
a robot comprising a robotic manipulator;
a welding-type tool coupled to the robotic manipulator;
a user interface;
memory circuitry storing a plurality of robot instructions relating to performance of a plurality of welding-type operations, the plurality of robot instructions comprising first machine readable robot instructions relating to performance of the plurality of welding-type operations; and
processing circuitry configured to:
in response determining that a human operator will perform one or more human performed welding-type operations of the plurality of welding-type operations, modify, or replace, one or more old robot instructions of the plurality of robot instructions with one or more new robot instructions,
the one or more old robot instructions and the one or more new robot instructions relating to the one or more human performed welding-type operations,
the one or more new robot instructions comprising second machine readable robot instructions indicating that the human operator will perform the one or more human performed welding-type operations, or instructing the robot to skip performance of the one or more human performed welding-type operations, and
control the robot to perform the plurality of welding-type operations according to the plurality of robot instructions.

9. The welding system of claim 8, wherein the processing circuitry is configured to determine that the human operator will perform the one or more human performed welding-type operations in response to receiving one or more inputs, via the user interface, indicating that a human operator will perform the one or more human performed welding-type operations.

10. The welding system of claim 9, wherein the processing circuitry is configured to output, via the user interface, a recommendation that the human operator perform the one or more human performed welding-type operations in response to determining that sensor data captured by a sensor indicates that a situation exists that the human operator is better equipped to deal with than the robot.

11. The welding system of claim 8, wherein the processing circuitry is configured to determine that the human operator will perform the one or more human performed welding-type operations in response to determining that sensor data captured by a sensor indicates that a situation exists that the human operator is better equipped to deal with than the robot.

12. The welding system of claim 11, wherein the situation comprises an issue with: a closeness or contact between two workpieces to be operated upon during the one or more human performed welding-type operations, a number of repeated overlapping passes required during the one or more human performed welding-type operations, an orientation of a joint between the two workpieces to be operated upon during the one or more human performed welding-type operations, or a position of a workpiece to be operated upon during the one or more human performed welding-type operations.

13. The welding system of claim 8, wherein the one or more new robot instructions specify how or where to position the robot during the human performed welding-type operation, or specify that the robot should delay continuing with performance of the plurality of welding-type operations until a particular condition is met.

14. The welding system of claim 8, wherein the one or more new robot instructions include a reference to, or a copy of, operator instruction data representative of one or more human perceptible operator instructions relating to human performance of the one or more human performed welding-type operations.

15. A welding system, comprising:
a robot comprising a robotic manipulator;
a welding-type tool coupled to the robotic manipulator;
a user interface;
memory circuitry storing:
operator instruction data representative of human perceptible instructions for human performance of a plurality of welding-type operations of a part assembly process, and
human-robot operation data that indicates which one or more human performed welding-type operations, of the plurality of welding-type operations, should be performed by a human operator, and which one or more robot performed welding-type operations, of the plurality of welding-type operations, should be performed by the robot; and
processing circuitry configured to:
generate machine readable robot instructions based on the operator instruction data and the human-robot operation data,
the machine readable robot instructions specifying how or when the robot should perform the one or more robot performed welding-type operations.

16. The welding system of claim 15, wherein the machine readable robot instructions further specify that the robot should not to perform the one or more human performed welding-type operations.

17. The welding system of claim 15, wherein the machine readable robot instructions further specify how or where to position the robot during the one or more human performed welding-type operations.

18. The welding system of claim 15, wherein the machine readable robot instructions further specify that the robot should delay continuing with performance of the one or more robot performance welding-type operations until a particular condition is met.

19. The welding system of claim 15, wherein the machine readable robot instructions include a reference to, or a copy of, operator instruction data representative of one or more human perceptible operator instructions relating to human performance of the one or more human performed welding-type operations.

20. The welding system of claim 15, wherein the user interface is configured to receive one or more inputs comprising the human-robot operation data, or the processing circuitry is further configured to generate the human-robot operation data based on an analysis of the operator instruction data.
